(19) United States
(12) Patent Application Publication
(10) Pub. No.: US 2025/0178356 A1
(43) Pub. Date: Jun. 5, 2025

(54) LIQUID DISCHARGE HEAD AND LIQUID DISCHARGE APPARATUS

(71) Applicant: CANON KABUSHIKI KAISHA, Tokyo (JP)

(72) Inventors: YUJI TAMARU, Tokyo (JP); SHINICHIRO MATSUMOTO, Kanagawa (JP); TAKUHIRO OGUSHI, Kanagawa (JP); HISAO OKITA, Kanagawa (JP); TOMOO IIZUMI, Kanagawa (JP); KIMIYUKI HAYASAKI, Kanagawa (JP); KENJIRO WATANABE, Tokyo (JP); CHIAKI MURAOKA, Saitama (JP); YOSUKE TAKAGI, Kanagawa (JP); SHIMPEI YOSHIKAWA, Kanagawa (JP)

(21) Appl. No.: 18/960,646

(22) Filed: Nov. 26, 2024

(30) Foreign Application Priority Data
Dec. 1, 2023 (JP) 2023-203996

(51) Int. Cl. B41J 2/175; B41J 2/18; B41J 29/00

(52) U.S. Cl. CPC B41J 2/17596; B41J 2/18; B41J 29/00

(57) ABSTRACT

A liquid discharge head or apparatus includes a discharge unit configured to discharge liquid inside a pressure chamber; a supply flow path through which liquid to be supplied to the pressure chamber flows; a collection flow path that is connected to the supply flow path through the pressure chamber and through which liquid collected from the pressure chamber flows; a circulating pump capable of supplying liquid to the pressure chamber through the supply flow path, collecting liquid from the pressure chamber through the collection flow path, and recirculating collected liquid to the supply flow path; and a pump drive circuit configured to generate the pump drive signal by stepping up and converting to alternating current a direct-current reference voltage signal having voltage lower than the peak-to-peak voltage of the pump drive signal.

### BACKGROUND OF THE DISCLOSURE

### Field of the Disclosure

The present disclosure relates to a liquid discharge head and a liquid discharge apparatus.

### Description of the Related Art

Recently in the field of ink-jet printer, an ink circulation-type liquid discharge apparatus capable of using special ink in accordance with a printing media for outputting a printed material at high image quality has been desired as a liquid discharge head scanning-type liquid discharge apparatus. In a disclosed configuration, an ink supply flow path and an ink collection flow path are provided for ink circulation and pressure difference is generated between the ink supply flow path and the ink collection flow path to obtain circulatory flow. A liquid discharge head disclosed in Japanese Patent Laid-Open No. 2018-030350 (hereinafter referred to as literature) includes a discharge unit for discharging ink, a supply-side accumulation unit for supplying ink to the discharge unit, and a collection-side accumulation unit for collecting ink from the discharge unit. The liquid discharge head also includes a circulating pump for recirculating ink from the collection-side accumulation unit to the supply-side accumulation unit, two pressure sensors provided at the two accumulation units, respectively, and a drive circuit configured to drive the circulating pump in accordance with outputs from the two pressure sensors.

In the above-described configuration, voltage for driving the circulating pump is initially 200 V and varies in the range of 120 V to 300 V. Such a configuration that supplies high voltage from the body of the liquid discharge apparatus to the liquid discharge head potentially causes undesirable effects on user handling at an electrical connection part between the liquid discharge apparatus and the liquid discharge head and on peripheral components. In a configuration in which the liquid discharge head on which the circulating pump is mounted moves in a main scanning direction, the circulating pump is preferably downsized for weight reduction and volume reduction. To ensure a necessary circulatory flow rate with the downsized circulating pump, voltage for driving the circulating pump needs to be further increased.

### SUMMARY OF THE DISCLOSURE

According to some embodiments of the present disclosure, a liquid discharge head includes: a discharge unit configured to discharge liquid inside a pressure chamber; a supply flow path through which liquid supplied to the pressure chamber flows; a collection flow path that is connected to the supply flow path through the pressure chamber and through which liquid collected from the pressure chamber flows; a circulating pump capable of supplying liquid to the pressure chamber through the supply flow path, collecting liquid from the pressure chamber through the collection flow path, and recirculating collected liquid to the supply flow path based on an alternating-current pump drive signal; and a pump drive circuit configured to generate the pump drive signal by stepping up and converting to alternating current a direct-current reference voltage signal having voltage lower than the peak-to-peak voltage of the pump drive signal.

Further features of the present disclosure will become apparent from the following description of exemplary embodiments with reference to the attached drawings.

### BRIEF DESCRIPTION OF THE DRAWINGS

FIG. 1A is a schematic configuration diagram of a liquid discharge apparatus of the present disclosure, and FIG. 1B is a control system block diagram of the liquid discharge apparatus.

FIG. 2A is an exploded perspective view of a liquid discharge head of the present disclosure, and FIG. 2B is a cross-sectional view of a discharge module.

FIG. 3 is an appearance schematic diagram of a liquid circulation unit of the present disclosure.

FIG. 4 is a schematic diagram of a liquid circulation path of the present disclosure.

FIG. 5 is a schematic diagram of pump drive wiring connection.

FIG. 6 is a configuration schematic diagram of a liquid discharge apparatus according to a first embodiment.

FIG. 7 is a circuit schematic diagram of a step-up circuit according to the first embodiment.

FIG. 8 is a circuit schematic diagram of an alternating-current conversion circuit according to the first embodiment.

FIG. 9 is a timing chart illustrating operation of a pump drive circuit according to the first embodiment.

FIG. 10 is a circuit schematic diagram of a step-up circuit according to a second embodiment.

FIG. 11 is a circuit schematic diagram of an alternating-current conversion circuit according to a third embodiment.

FIG. 12 is a circuit schematic diagram of an alternating-current conversion circuit according to a fourth embodiment.

FIG. 13 is a configuration schematic diagram of a liquid discharge apparatus according to a fifth embodiment.

FIG. 14 is a circuit schematic diagram of a step-up/alternating-current conversion circuit according to the fifth embodiment.

FIG. 15 is a timing chart illustrating operation of a pump drive circuit according to the fifth embodiment.

FIG. 16 is a configuration schematic diagram of a liquid discharge apparatus according to a sixth embodiment.

FIG. 17 is a configuration schematic diagram of a liquid discharge apparatus according to a seventh embodiment.

FIG. 18 is a configuration schematic diagram of a liquid discharge apparatus according to an eighth embodiment.

FIG. 19 is a configuration schematic diagram of a liquid discharge apparatus according to a ninth embodiment.

FIG. 20 is a configuration schematic diagram of a liquid discharge apparatus according to a tenth embodiment.

FIG. 21 is a circuit schematic diagram of a step-up circuit and a voltage divider circuit according to an eleventh embodiment.

FIG. 22 is a configuration schematic diagram of a liquid discharge apparatus according to the eleventh embodiment.

FIG. 23 is a configuration schematic diagram of a liquid discharge apparatus according to a twelfth embodiment.

FIG. 24 is a configuration schematic diagram of a liquid discharge apparatus according to a thirteenth embodiment.

FIG. 25 is a schematic configuration diagram of a main part of a liquid discharge apparatus according to a fourteenth embodiment.

FIG. 26 is a configuration schematic diagram of the liquid discharge apparatus according to the fourteenth embodiment.

FIG. 27 is a configuration schematic diagram of a liquid discharge apparatus according to a fifteenth embodiment.

FIG. 28 is a configuration schematic diagram of a liquid discharge apparatus according to a sixteenth embodiment.

FIG. 29 is a configuration schematic diagram of a liquid discharge apparatus according to a seventeenth embodiment.

FIG. 30 is a configuration schematic diagram of a liquid discharge apparatus according to an eighteenth embodiment.

FIG. 31 is a configuration schematic diagram of a liquid discharge apparatus according to a nineteenth embodiment.

FIG. 32 is a configuration schematic diagram of a liquid discharge apparatus according to a twentieth embodiment.

FIG. 33 is a configuration schematic diagram of a liquid discharge apparatus according to a twenty-first embodiment.

FIG. 34 is a configuration schematic diagram of a liquid discharge apparatus according to a twenty-second embodiment.

### DESCRIPTION OF THE EMBODIMENTS

Various exemplary embodiments, features, and aspects will be described below in detail with reference to the accompanying drawings. The embodiments below do not limit the disclosure according to the claims. Not all of a plurality of features written in the embodiments are necessarily essential for the disclosure, and the plurality of features may be optionally combined. Moreover, identical or equivalent components in the accompanying drawings are denoted by the same reference number, and duplicate description thereof is omitted in some cases.

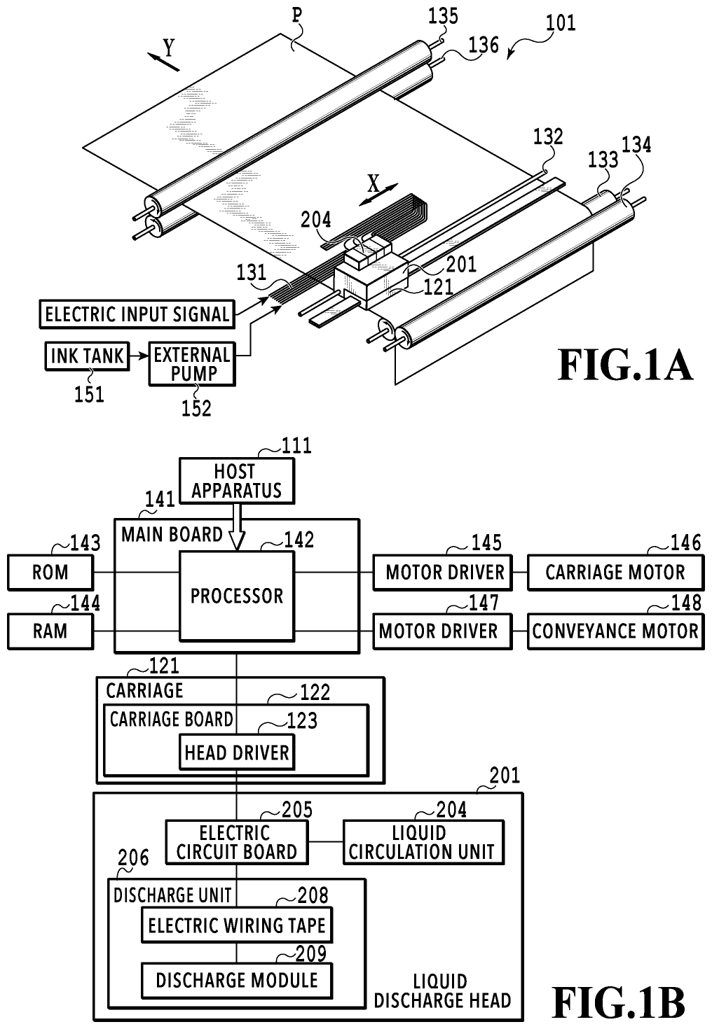

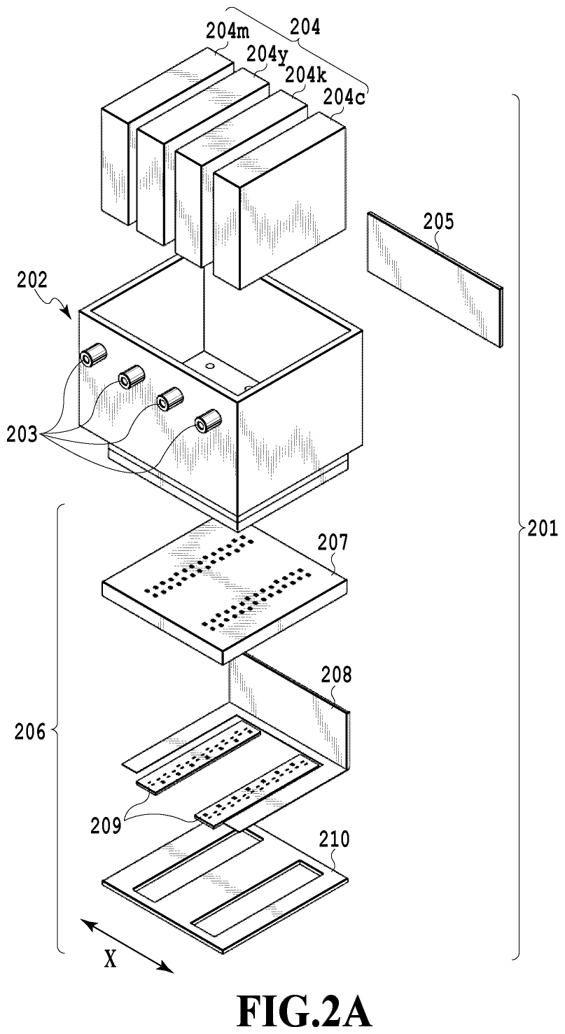

FIG. 1A is a schematic perspective view of schematically illustrating a liquid discharge apparatus of the present disclosure, and FIG. 1B is a functional block diagram of the liquid discharge apparatus of the present disclosure.

A liquid discharge apparatus according to the present embodiment is a serial scanning ink-jet liquid discharge apparatus (hereinafter simply referred to as “liquid discharge apparatus”) 101 configured to print an image on a printing media P by discharging ink from a liquid discharge head 201. The liquid discharge head 201 as an ink-jet liquid discharge head is mounted on a carriage 121. As illustrated with a bidirectional arrow X, the carriage 121 reciprocates along a guide shaft 132 extending in a main scanning direction. As illustrated with an arrow Y, the printing media P is conveyed in a sub scanning direction intersecting (in the present example, orthogonal to) the main scanning direction by conveyance rollers 133, 134, 135, and 136.

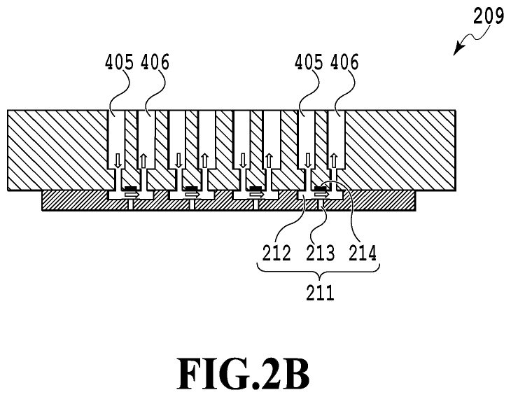

The liquid discharge head 201 includes a plurality of liquid circulation units 204 and a discharge unit 206. The plurality of liquid circulation unit 204 circulate ink flowing through the discharge unit 206. A discharge module 209 provided at the discharge unit 206 is formed with a plurality of discharge elements 211 (refer to FIG. 2B) for discharging ink. An element drive signal generated by a head driver 123 drives the plurality of discharge elements 211 for ink discharge and is supplied to the plurality of discharge elements 211 formed in the discharge module 209 through an electric circuit board 205 and an electric wiring tape 208.

A guide 131 is connected to the carriage 121. Electric wires and supply tubes are disposed at the guide 131. Through the electric wires and supply tubes, electric signals and inks for ink discharge by the plurality of discharge elements 211 formed in the discharge module 209 are supplied to the carriage 121.

A processor 142 such as a central processing unit (CPU) or the like controls the liquid discharge apparatus 101 by reading and executing a computer program stored in a read-only memory (ROM) 143. A random access memory (RAM) 144 is used as a work area or the like when the processor 142 reads and executes a computer program. The processor 142 controls the head driver 123 based on image data supplied from a host apparatus 111 connected to the liquid discharge apparatus 101. The processor 142 also controls a carriage motor 146 for moving the carriage 121 through a motor driver 145. The processor 142 further controls a conveyance motor 148 for conveying the printing media P with the conveyance rollers 133, 134, 135, and 136 through a motor driver 147.

The liquid discharge head 201 can perform full-color printing with cyan, magenta, yellow, black (CMYK) inks. A cap unit (not illustrated) is disposed at a position adjacent to a conveyance path of the printing media P. The cap unit relatively moves to a position for covering a discharge surface of the liquid discharge head 201 in a duration when the liquid discharge apparatus 101 is not performing printing operation. Then, the cap unit performs capping for preventing drying of discharge ports 213 (refer to FIG. 2B) formed through the discharge surface, and suction operation for ink filling of the head and function recovery of the head.

### Configuration of Liquid Discharge Head

FIG. 2A illustrates an exploded perspective view of the liquid discharge head 201, and FIG. 2B is a cross-sectional view of the discharge module 209 of the present embodiment. As illustrated in FIG. 2A, the liquid discharge head 201 includes the plurality of liquid circulation units 204 as described above. The plurality of liquid circulation units 204 include liquid circulation units 204m, 204y, 204k, and 204c corresponding to inks of the respective colors, which are housed inside a flow path member 202. Each liquid circulation unit 204 is provided with a flow path, and the flow path member 202 is provided with a flow path. Schemes of connecting these flow paths include a screw fastening scheme with a seal member sandwiched between the flow paths, and a connection scheme by welding. Note that the number of ink kinds is four in the discharge head 201 according to the present embodiment, and accordingly, for example, the number of liquid circulation units 204 is four, but the present disclosure is not limited thereto. The number of ink kinds is four in the following description, but this does not limit the number of ink kinds to four in the present disclosure.

As illustrated in FIG. 2A, four joints 203 are disposed at the flow path member 202 for receiving ink supplied from a body of the liquid discharge apparatus 101 through the supply tubes disposed at the guide 131. The four joints 203 are connected to the liquid circulation units 204m, 204y, 204k, and 204c on a one-to-one basis. When the liquid discharge head 201 is mounted on the body of the liquid discharge apparatus 101, the supply tubes connected to ink tanks 151 (refer to FIGS. 1A and 1B) of the respective colors are connected to the joints 203. Inks of the colors supplied from the respective supply tubes are supplied to the liquid circulation units 204m, 204y, 204k, and 204c through the joints 203. The discharge unit 206 is connected to a bottom surface of the flow path member 202. The inks of the respective colors supplied to the liquid circulation units 204m, 204y, 204k, and 204c are supplied to the discharge unit 206 through the flow path member 202.

As illustrated in FIG. 2A, the discharge unit 206 includes the discharge module 209 in which the plurality of discharge elements 211 for ink discharge are arrayed, and a support member 207. The discharge unit 206 further includes the electric wiring tape 208 for transferring electric signals to the discharge module 209, and a cover member 210 that covers the electric wiring tape 208. The discharge module 209 and the electric wiring tape 208 are bonded and fixed to the support member 207 and further bonded and joined to the cover member 210 to cover their surfaces. The discharge module 209 and the electric wiring tape 208 are electrically connected to each other by wire bonding. A scheme such as flying lead bonding can be used for the electrical connection. In the cover member 210, places corresponding to the discharge module 209 are opened. A bonding scheme using a bonding agent or a fixation scheme by screw fastening with a seal member sandwiched can be used as the scheme of connection of the discharge unit 206 and the flow path member 202.

A surface opposite a surface of the flow path member 202 where the joints 203 are disposed is a contact surface. The electric circuit board 205 is disposed on the contact surface. The electric circuit board 205 may be fixed to the flow path member 202 by swaging or with a bonding agent or may be fixed with a double-sided adhesive tape.

As illustrated in FIGS. 1A and 1B, the electric circuit board 205 relays electric signals transmitted between a carriage board 122 and the discharge unit 206. The electric circuit board 205 also relays electric signals transmitted between the carriage board 122 and each liquid circulation unit 204.

The electric wiring tape 208 included in the discharge unit 206 is connected to the electric circuit board 205 by anisotropic conductive film (ACF) press bonding, wire bonding, flying lead bonding, or the like. The electric wiring tape 208 relays electric signals transmitted between the electric circuit board 205 and the discharge module 209 included in the discharge unit 206.

### Description of Circulation Flow Path

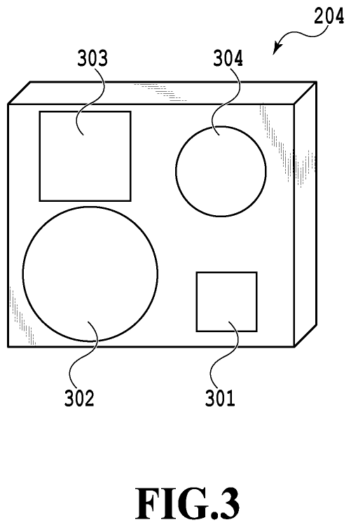

FIG. 3 is an appearance schematic diagram of each liquid circulation unit 204 applied to the liquid discharge apparatus 101. One liquid circulation unit 204 is disposed for each color in the flow path member 202. A first pressure adjustment mechanism 302, a second pressure adjustment mechanism 304, a filter 301, and a circulating pump 303 are disposed in each liquid circulation unit 204.

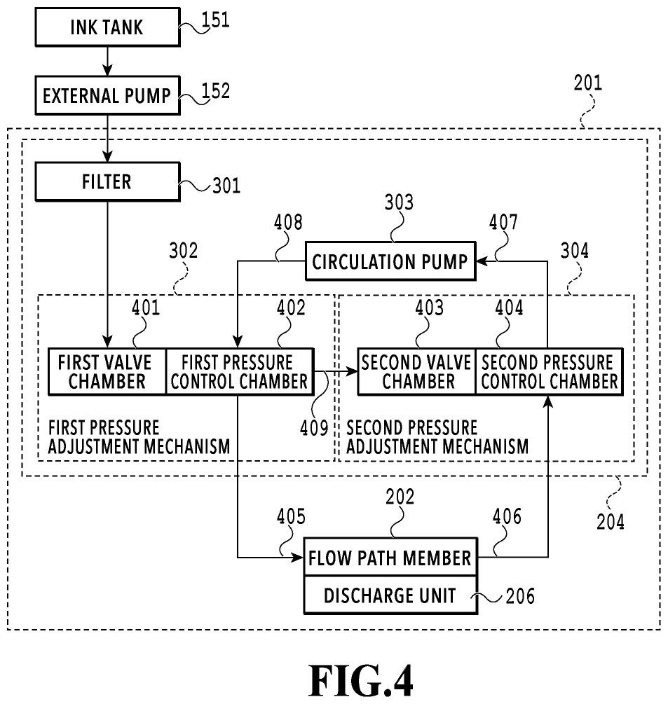

FIG. 4 is a schematic diagram illustrating a liquid circulation flow path for one color, which is applied to the liquid discharge apparatus 101. Ink is supplied under pressurization from the corresponding ink tank 151 to the liquid discharge head 201 by an external pump 152. The ink is subjected to dust removal through the filter 301 and then supplied to a first valve chamber 401 of the first pressure adjustment mechanism 302. Thereafter, the pressure of the ink is adjusted to supply side pressure when the ink flows to a first pressure control chamber 402 communicating with the first valve chamber 401 through a first valve (not illustrated).

The circulating pump 303 is a piezoelectric diaphragm pump configured to change volume in a pump chamber by inputting of a drive voltage signal that alternately has pump drive voltage and is supplied to two piezoelectric elements bonded to a diaphragm so that two check valves alternately move through pressure variation to transfer liquid. The circulating pump 303 drives to transfer ink from a pump entrance flow path 407 on the downstream side to a pump exit flow path 408 on the upstream side.

With the drive of the circulating pump 303, the ink with the adjusted pressure in the first pressure control chamber 402 is supplied to a supply flow path 405 and a bypass flow path 409. The supply flow path 405 is a flow path formed in the flow path member 202 and connected to the discharge unit 206. Similarly, a collection flow path 406 is a flow path formed in the flow path member 202 and connected to the discharge unit 206.

The discharge unit 206 includes the discharge module 209, and the discharge module 209 is formed with the plurality of discharge elements 211. Each discharge element 211 includes a pressure chamber 212, a discharge port 213, and an energy conversion element 214. The pressure chamber 212 and the discharge port 213 communicate with each other. The discharge ports 213 are arrayed as openings on the discharge surface. The ink supplied to the supply flow path 405 is supplied to the plurality of pressure chambers 212 formed in the discharge module 209 of the discharge unit 206. The ink in each pressure chamber 212 is discharged from the discharge port 213 with energy output from the energy conversion element 214. The ink not discharged from the discharge port 213 is discharged from the pressure chamber 212 to the collection flow path 406 and thereafter collected by a second pressure control chamber 404 of the second pressure adjustment mechanism 304.

Ink supplied to a second valve chamber 403 of the second pressure adjustment mechanism 304 is supplied to the second pressure control chamber 404 communicating with the second valve chamber 403 through a second valve (not illustrated). Note that the pressure of the second pressure control chamber 404 is adjusted to collection side pressure. At printing, the collection side pressure is lower than the supply side pressure.

The ink supplied to the second pressure control chamber 404 is supplied to the pump entrance flow path 407 and passes through the circulating pump 303, and then is supplied to the pump exit flow path 408 and thereafter recirculated to the first pressure control chamber 402. However, at least part of the ink supplied to the second pressure control chamber 404 is supplied to the flow path member 202 through the collection flow path 406 in some cases. With this configuration in which the circulating pump 303 circulates ink through the discharge elements 211 formed at the discharge module 209, it is possible to suppress thickening of ink in the discharge module 209.

The circulation flow path is not limited to a configuration through the discharge module 209 but may have any configuration that circulates ink in the discharge unit 206 as long as the effect of suppressing ink thickening in the discharge module 209 is obtained.

### Description of Circulating Pump Drive Mechanism

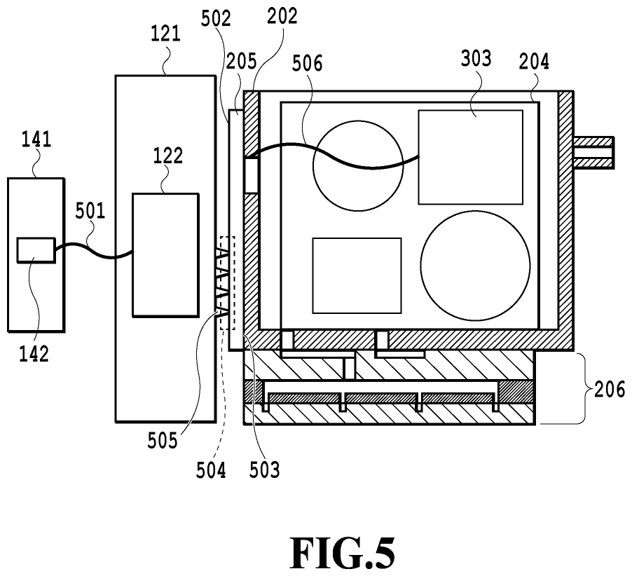

FIG. 5 is a schematic diagram illustrating a configuration for electrical connection for driving the circulating pump 303. Various drive signals are transferred from the processor 142 mounted on a main board 141 in the liquid discharge apparatus 101 to the carriage board 122 mounted on the carriage 121 through the main board 141 and a flexible flat cable (FFC) 501. The various drive signals include signals related to the circulating pump 303 included in each liquid circulation unit 204 and signals related to the discharge unit 206.

In addition, various drive signals are transferred from the carriage board 122 to the electric circuit board 205 through an electrical connection part 504 by contact connection. As illustrated in FIG. 5, the electrical connection part 504 includes a plurality of pins 505 on the carriage 121 side and a plurality of pads (not illustrated) disposed on a pad surface 502 of the electric circuit board 205, and electrical connection is established when each pin contacts the corresponding pad.

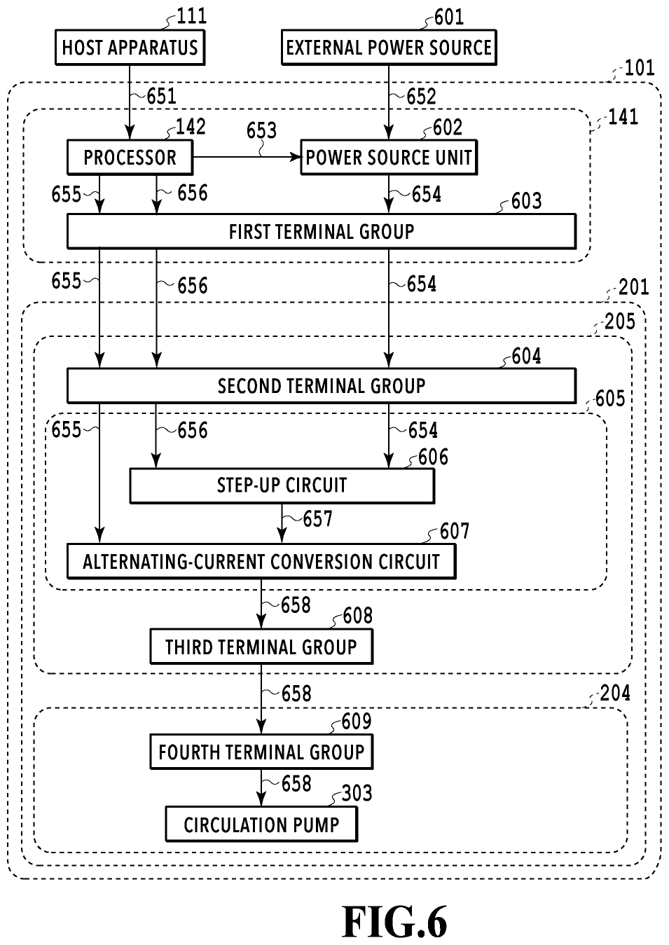

As described later with reference to, for example, FIG. 6, a step-up circuit 606 as a step-up unit configured to step up reference voltage of a reference voltage signal 654 based on a step-up control signal 656 is disposed on the electric circuit board 205. The step-up circuit 606 generates a drive voltage signal 657 having pump drive voltage by stepping up the reference voltage to voltage designated by the step-up control signal 656. The drive voltage signal 657 is converted into an alternating-current pump drive signal 658 by an alternating-current conversion circuit 607 (refer to FIG. 6, for example) and then supplied to a connector terminal (not illustrated) disposed on the electric circuit board 205. The pump drive signal 658 is supplied to the four circulating pumps 303 through a harness wire 506 connected to the connector terminal. The four circulating pumps 303 is driven for ink circulation by the pump drive signal 658 having the pump drive voltage as peak-to-peak voltage. Note that the peak-to-peak voltage is voltage obtained by subtracting the minimum voltage of a signal with non-constant voltage from the maximum voltage thereof.

An electrical line path from the step-up circuit 606 to each circulating pump 303 is preferably provided at a place where the electrical line path is unlikely to be touched by a user with hand. For example, a configuration is preferable in which the step-up circuit 606 is provided on a surface of the electric circuit board 205 on the flow path member 202 side and the electrical line path from the step-up circuit 606 to each circulating pump 303 is covered by the flow path member 202.

A configuration may be employed in which the carriage board 122 and the electric circuit board 205 are integrated. A configuration may be employed in which the electric circuit board 205 cannot be removed the carriage board 122 by the user. In such a configuration, the step-up circuit 606 may be provided on the carriage board 122.

### First Embodiment

FIG. 6 is a configuration schematic diagram of the liquid discharge apparatus 101 according to a first embodiment.

A printing signal 651 is supplied from the host apparatus 111 to the processor 142 provided in the liquid discharge apparatus 101. Electric power 652 is supplied from an external power source 601 to a power source unit 602 provided in the liquid discharge apparatus 101. When supplied with the printing signal 651, the processor 142 activates a power source control signal 653 to the power source unit 602. In the present embodiment, the power source control signal 653 is active high and activated by changing its signal voltage from 0 volts (V) to 3.3 V. Note that the signal voltage is equal to signal potential relative to ground potential. Hereinafter, “voltage” means potential relative to ground potential. When supplied with the active power source control signal 653, the power source unit 602 supplies the reference voltage signal 654 to a first terminal group 603. In the present embodiment, the reference voltage signal 654 has a direct-current voltage of 24 V. Note that 24 V is merely exemplary and the reference voltage signal 654 only needs to be a direct-current signal having constant voltage lower than the peak-to-peak voltage of the pump drive signal. The reference voltage is preferably equal to or lower than voltage of electric power for circuits on the electric circuit board 205 to operate, but the present disclosure is not limited thereto. Moreover, the reference voltage is preferably stable and thus preferably, for example, voltage generated by a regulator on the main board 141. The voltage of the reference voltage signal is preferably voltage with which the user is not damaged in a case where the user touches wiring for the reference voltage signal. Thus, the reference voltage signal 654 may have, for example, a direct-current voltage of 12 V or a direct-current voltage of 5 V. When supplied with the printing signal 651, the processor 142 supplies an alternating-current conversion control signal 655 and the step-up control signal 656 to the first terminal group 603. The alternating-current conversion control signal 655 is constituted by signals 655a and 655b corresponding to respective counter electrode terminals provided at the circulating pump 303. In the present embodiment, the power source control signal 653 is active high and activated by changing its signal voltage from 0 V to 3.3 V. The step-up control signal 656 is a signal that drives the step-up circuit 606 by transitioning between 0 V and 24 V. The first terminal group 603 is a terminal group provided in the liquid discharge apparatus 101. The first terminal group 603 supplies signals and voltage to a second terminal group 604 provided at the electric circuit board 205 mounted on the liquid discharge head 201. According to the present embodiment, the highest voltage among the voltages of signals output from the first terminal group 603 is 24 V, which is relatively low.

The second terminal group 604 supplies, to the step-up circuit 606, the reference voltage signal 654 and the step-up control signal 656 supplied from the first terminal group 603. In accordance with the step-up control signal 656, the step-up circuit 606 generates the drive voltage signal 657 having a direct-current voltage of 72 V based on the reference voltage signal 654 having a direct-current voltage of 24 V and supplies the signal 657 to the alternating-current conversion circuit 607. A specific configuration of the step-up circuit 606 will be described later. The alternating-current conversion circuit 607 generates the alternating-current pump drive signal 658 based on the drive voltage signal 657 and the alternating-current conversion control signal 655 supplied from the second terminal group 604 and supplies the signal 658 to a third terminal group 608. In other words, the alternating-current conversion circuit 607 generates the pump drive signal 658 by converting the direct-current drive voltage signal 657 to alternating-current (converting from direct-current to alternating-current) based on the alternating-current conversion control signal 655. Note that the step-up circuit 606 and the alternating-current conversion circuit 607 constitute a pump drive circuit 605 as illustrated in FIG. 6. The third terminal group 608 includes two terminals corresponding to the counter electrode terminals provided at the circulating pump 303, and the pump drive signal 658 includes two signals. The two signals included in the pump drive signal 658 are supplied to the two terminals corresponding to the counter electrode terminals provided at the circulating pump 303 on a one-to-one basis. The pump drive signal 658 transitions between 0 V and 72 V as pump drive voltage at a frequency corresponding to the drive frequency of the pump. The reference voltage signal 654 is a direct-current signal of 24 V. Thus, the voltage of the reference voltage signal 654 is lower than the peak-to-peak voltage of the pump drive signal 658. The third terminal group 608 is provided on the electric circuit board 205. The pump drive signal 658 is supplied from the third terminal group 608 to a fourth terminal group 609 provided in each liquid circulation unit 204 through the harness wire 506. The fourth terminal group 609 supplies the supplied pump drive signal 658 to the circulating pump 303. The circulating pump 303 is driven in accordance with the supplied pump drive signal 658.

Note that the step-up control signal 656 is, for example, a pulse-width modulation (PWM) signal and the voltage of the drive voltage signal 657 output from the step-up circuit 606 can be adjusted by adjusting the duty of the PWM signal.

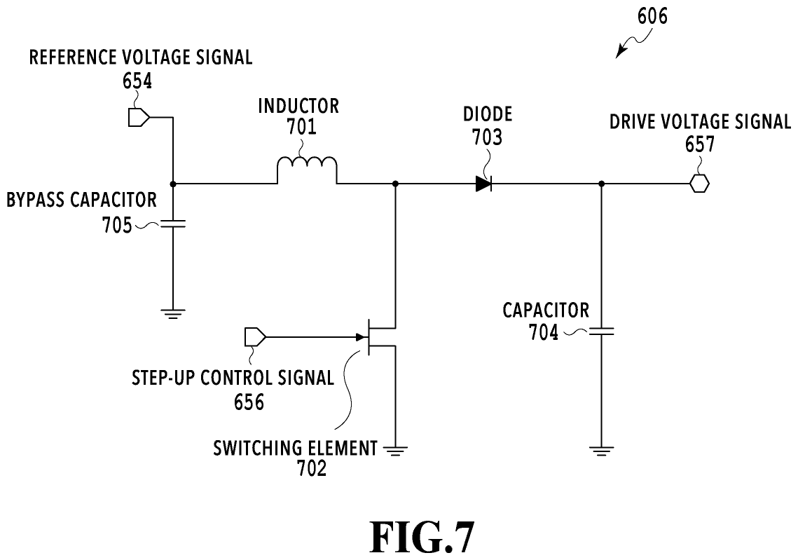

FIG. 7 is a circuit schematic diagram of the step-up circuit 606 according to the first embodiment. The step-up circuit 606 illustrated in FIG. 7 is a step-up chopper circuit. The reference voltage signal 654 having 24 V is supplied to the first terminal of an inductor 701 and the first terminal of a bypass capacitor 705. In the present embodiment, a chip inductor is used as the inductor 701. The second terminal of the inductor 701 is connected to the drain of a switching element 702 and the anode of a diode 703. The gate of the switching element 702 is supplied with the step-up control signal 656 and the source thereof is grounded. In the present embodiment, an n-channel FET is used as the switching element 702. The cathode of the diode 703 is connected to the first terminal of a capacitor 704, and the drive voltage signal 657 is output from this connection point. The second terminal of the capacitor 704 and the second terminal of the bypass capacitor 705 are grounded.

In a state in which the step-up control signal 656 is at 24 V as active voltage, the switching element 702 is active and accordingly, current flows from an input terminal for the reference voltage signal 654 to the ground through the inductor 701 and the switching element 702. Note that the active voltage is equal to active potential relative to ground potential. The switching element 702 is switched off when the step-up control signal 656 transitions from the active voltage to 0 V as ground voltage. However, since the inductor 701 is positioned between the input terminal for the reference voltage signal 654 and the drain of the switching element 702, electric charge flows into the capacitor 704 through the diode 703 by counter electromotive force generated at transition. The electric charge having flowed and accumulated in the capacitor 704 cannot return to the anode side of the diode 703 because of the diode 703. In this manner, electric charge flows and accumulates in the capacitor 704 each time the step-up control signal 656 drives the switching element 702, and accordingly, the drive voltage signal 657 is stepped up to voltage higher than the reference voltage signal 654. In the present embodiment, the step-up control signal 656 is supplied to the switching element 702 so that the voltage of the drive voltage signal 657 becomes 72 V.

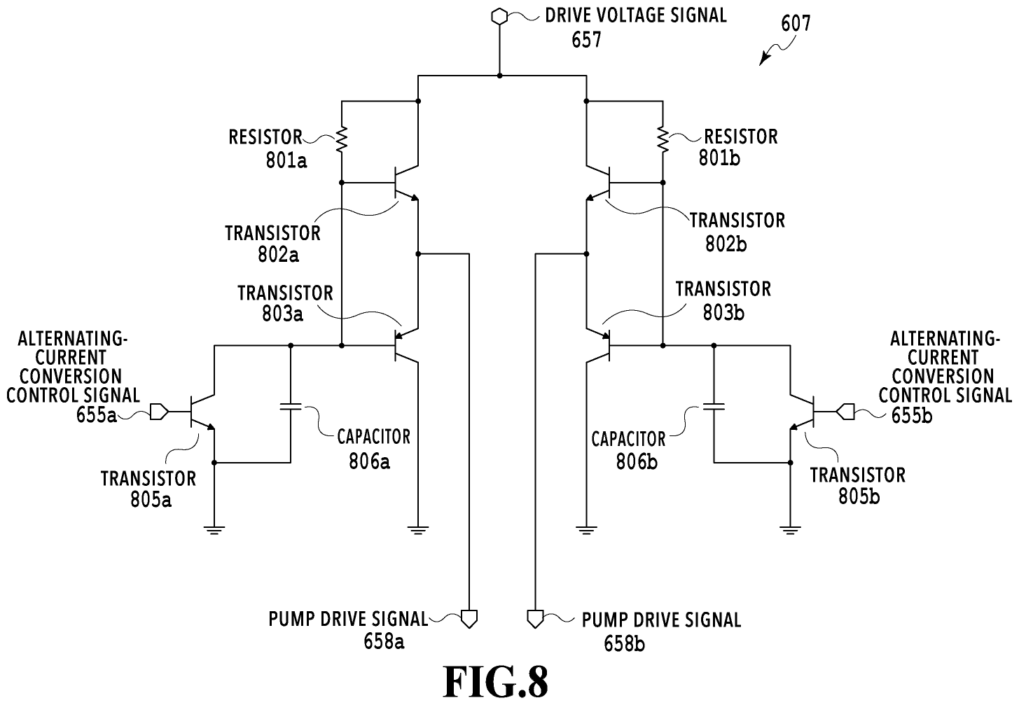

FIG. 8 is a circuit schematic diagram of the alternating-current conversion circuit 607 according to the first embodiment. The drive voltage signal 657 having 72 V is supplied to the first terminal of a resistor 801a, the first terminal of a resistor 801b, the collector of a transistor 802a, and the collector of a transistor 802b. In the present embodiment, NPN-type transistors are used as the transistors 802a and 802b. The emitter of the transistor 802a and the emitter of the transistor 802b are connected to the emitter of a transistor 803a and the emitter of a transistor 803b, respectively. In the present embodiment, PNP-type transistors are used as the transistors 803a and 803b. A pump drive signal 658a is output from a connection point between the emitter of the transistor 802a and the emitter of the transistor 803a. Similarly, a pump drive signal 658b is output from a connection point between the emitter of the transistor 802b and the emitter of the transistor 803b.

The collectors of the transistors 803a and 803b are grounded. The second terminal of the resistor 801a is connected to the base of the transistor 802a, the base of the transistor 803a, the collector of a transistor 805a, and the first terminal of a capacitor 806a. Similarly, the second terminal of the resistor 801b is connected to the base of the transistor 802b, the base of the transistor 803b, the collector of a transistor 805b, and the first terminal of a capacitor 806b.

In the present embodiment, NPN-type transistors are used as the transistors 805a and 805b. The alternating-current conversion control signals 655a and 655b are supplied to the bases of the transistors 805a and 805b, respectively. The emitters of the transistors 805a and 805b and the second terminals of the capacitors 806a and 806b are grounded.

Note that “a” and “b” attached to reference signs 655, 801 to 803, 805, and 806 correspond to counter electrode terminals “a” and “b”, respectively, provided at the circulating pump 303.

The following describes operation of the alternating-current conversion circuit 607 illustrated in FIG. 8. Since the operation is common to sequence “a” and sequence “b”, the above-described “a” and “b” are omitted in the description.

The transistor 805 is opened in a case where the alternating-current conversion control signal 655 is at the ground voltage of 0 V. In this state, the drive voltage signal 657 is supplied to the bases of the transistors 802 and 803 through the resistor 801. Then, base current flows from the base to the emitter of the transistor 802. Accordingly, the transistor 802 becomes active, and thus the voltage of the pump drive signal 658 becomes equal to the voltage of the drive voltage signal 657, which is 72 V. At the same time, the emitter and base of the transistor 803 are at the same voltage, and accordingly, the transistor 803 is opened.

In a case where the alternating-current conversion control signal 655 is at the active voltage of 3.3 V, base current flows from the base to the emitter of the transistor 805. Accordingly, the transistor 805 becomes active, and thus the bases of the transistors 802 and 803 are grounded. Base current flows from the emitter to the base of the transistor 803 in a state in which the pump drive signal 658 has the voltage of 72 V for driving the pump. Accordingly, the transistor 803 becomes active, and thus, the voltage of the pump drive signal 658 becomes equal to the ground voltage of 0 V, which is the collector voltage of the transistor 803. At the same time, the transistor 802 has the same voltage at the base and the emitter and accordingly, is opened.

As described above, the voltage of the pump drive signal 658 is equal to the voltage of the drive voltage signal 657 in a case where the alternating-current conversion control signal 655 has the ground voltage of 0 V. The voltage of the pump drive signal 658 becomes equal to the ground voltage of 0 V in a case where the alternating-current conversion control signal 655 has the active voltage of 3.3 V. The voltages of the alternating-current conversion control signals 655a and 655b complementarily repeat the ground voltage and the active voltage of 3.3 V, and accordingly, the voltages of the pump drive signals 658a and 658b complementarily repeat the ground voltage and 72 V as the voltage of the drive voltage signal 657.

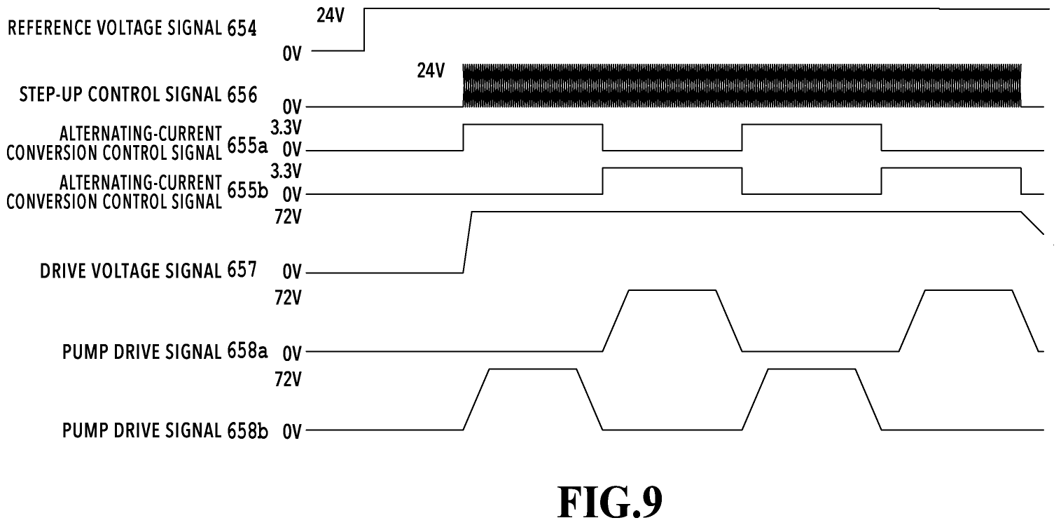

FIG. 9 is a timing chart illustrating operation of the pump drive circuit 605 according to the first embodiment. First, the reference voltage signal 654 transitions from the ground voltage of 0 V to 24 V. Thereafter, the step-up control signal 656 repeatedly transitions to the ground voltage of 0 V and the active voltage of 24 V in accordance with defined rules. Based on the step-up control signal 656, the drive voltage signal 657 is stepped up from the ground voltage of 0 V to 72 V, which is voltage necessary for pump drive. Thereafter, the voltages of the alternating-current conversion control signals 655a and 655b complementarily repeat 0 V and 3.3 V, and accordingly, the voltages of the pump drive signals 658a and 658b complementarily repeat 0 V and 72 V.

As described above, what is called a B-class amplifier circuit can be used as the alternating-current conversion circuit 607. Moreover, in the present embodiment, a signal having high voltage that is necessary for driving the circulating pump 303 can be prevented from existing on a path from the first terminal group 603 to the second terminal group 604. Thus, a signal having high voltage can be prevented from existing at the flexible flat cable (FFC) 501, the carriage board 122, and the electrical connection part 504. Accordingly, undesirable influence on user handling and peripheral components due to electrical connection can be reduced.

### Second Embodiment

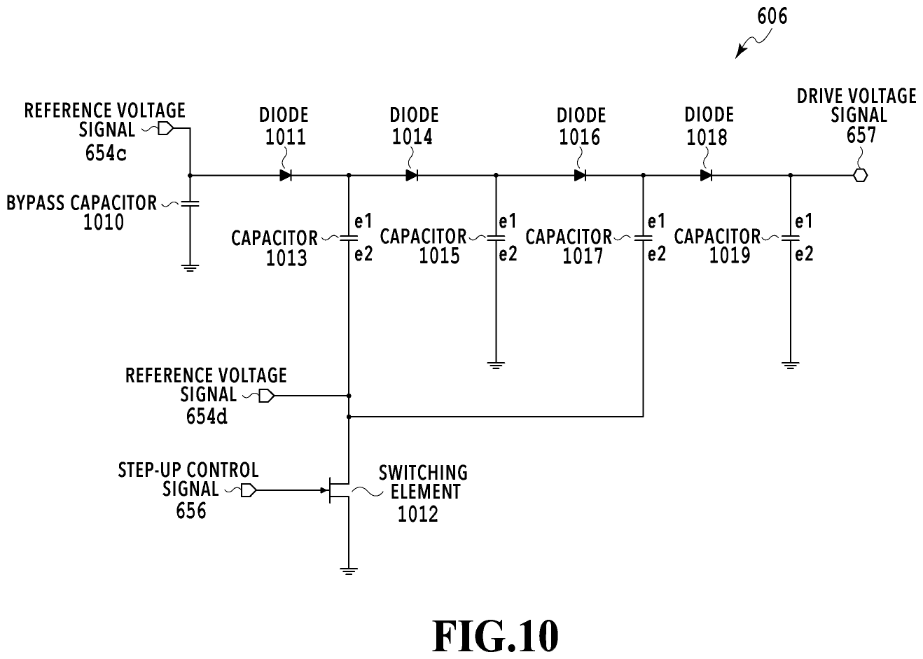

FIG. 10 is a circuit schematic diagram of the step-up circuit 606 according to second embodiment. The step-up circuit 606 illustrated in FIG. 10 is a charge pump circuit. A reference voltage signal 654c having 24 V is supplied to the anode of a diode 1011 and the first terminal of a bypass capacitor 1010. The cathode of the diode 1011 is connected to the first terminal of a capacitor 1013 and the anode of a diode 1014. The second terminal of the capacitor 1013 is connected to the drain of a switching element 1012 and the second terminal of a capacitor 1017. A reference voltage signal 654d is supplied to these mutually connected three terminals. The step-up control signal 656 is supplied to the gate of the switching element 1012, and the source of the switching element 1012 is grounded. In the present embodiment, an n-channel FET is used as the switching element 1012. The cathode of the diode 1014 is connected to the first terminal of a capacitor 1015 and the anode of a diode 1016.

The cathode of the diode 1016 is connected to the first terminal of the capacitor 1017 and the anode of a diode 1018. The cathode of the diode 1018 is connected to the first terminal of a capacitor 1019, and the drive voltage signal 657 is output from here. The second terminals of the capacitors 1015 and 1019 are grounded.

Since the switching element 1012 is active in a state in which the step-up control signal 656 is at the active potential of 24 V, the second terminals of the capacitor 1013 and the capacitor 1017 are grounded. In this state, electric charge flows into four capacitors through four diodes so that the voltages of the first terminals of the four capacitors become equal to the voltage of the reference voltage signal 654c. The four capacitors are the capacitors 1013, 1015, 1017, and 1019, and the four diodes are the diodes 1011, 1014, 1016, and 1018. Subsequently, the switching element 1012 is switched off as the voltage of the step-up control signal 656 transitions from the active voltage to the ground voltage. Accordingly, the voltage of the second terminal of the capacitor 1013 becomes equal to the voltage of the reference voltage signal 654d, which is 24 V. There is the potential difference of 24 V between the terminals of the capacitor 1013. Accordingly, electric charge flows from a terminal for the reference voltage signal 654c into the capacitor 1013 through the diode 1011 so that the voltage of the first terminal of the capacitor 1013 has the potential difference of 24 V between the terminals relative to the voltage of the second terminal, which is 24 V. As a result, the voltage of the first terminal of the capacitor 1013 becomes 48 V relative to the ground voltage of 0 V. Then, since the diode 1014 has 48 V on the anode side and 24 V on the cathode side, electric charge flows into the capacitor 1015 through the diode 1014 so that 48 V is obtained on the cathode side. Similarly, electric charge flows into the capacitors 1017 and 1019 so that 48 V is obtained on the cathode sides of the diodes 1016 and 1018.

Subsequently, the switching element 1012 becomes active when the step-up control signal 656 transitions from the ground voltage to the active voltage. Accordingly, the second terminals of the capacitors 1013 and 1017 are grounded. Further, the switching element 1012 is switched off when the step-up control signal 656 transitions from the active voltage to the ground voltage. Accordingly, the voltage of the second terminal of the capacitor 1017 becomes equal to the voltage of the reference voltage signal 654d, which is 24 V. There is the potential difference of 48 V between the terminals of the capacitor 1017. Thus, electric charge flows from the terminal for the reference voltage signal 654c into the capacitor 1017 through the diode 1016 so that the voltage of the first terminal of the capacitor 1013 has the potential difference of 48 V between the terminals relative to the voltage of the second terminal, which is 24 V. In other words, electric charge flows into the capacitor 1017 through the diode 1016 so that the potential of the first terminal of the capacitor 1017 becomes equal to 72 V relative to the ground voltage of 0 V. Accordingly, since the diode 1018 has 72 V on the anode side and 48 V on the cathode side, electric charge flows into the capacitor 1019 through the diode 1018 so that 72 V is obtained on the cathode side.

In this manner, what is called a charge pump circuit can be used as the step-up circuit 606 as described above.

### Third Embodiment

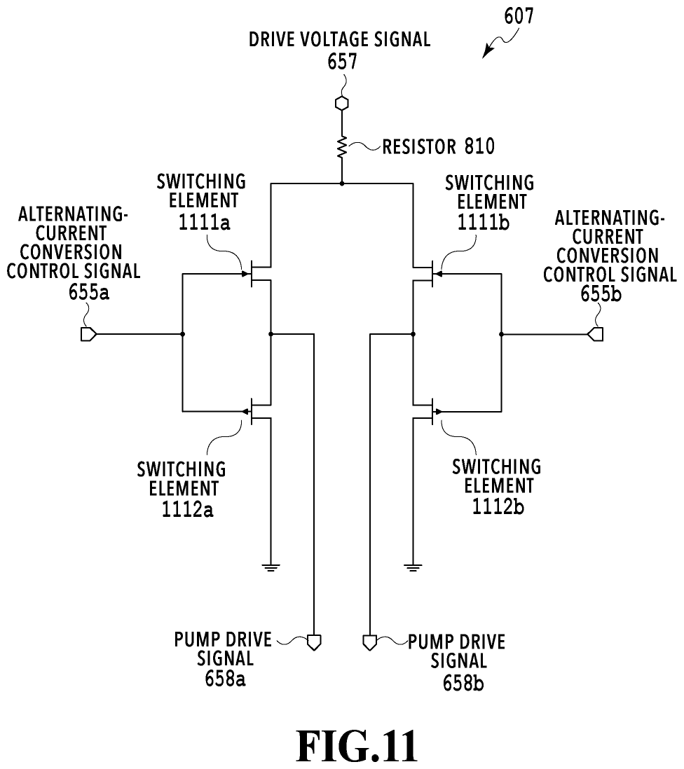

FIG. 11 is a circuit schematic diagram of the alternating-current conversion circuit 607 in a third embodiment. The drive voltage signal 657 having 72 V is supplied to the sources of switching elements 1111a and 1111b through a resistor 1110. The drains of the switching elements 1111a and 1111b are connected to the drains of switching elements 1112a and 1112b, respectively. The pump drive signal 658a is output from a connection point between the drain of the switching element 1111a and the drain of the switching element 1112a. Similarly, the pump drive signal 658b is output from a connection point between the drain of the switching element 1111b and the drain of the switching element 1112b. The sources of the switching elements 1112a and 1112b are grounded. The alternating-current conversion control signal 655a is supplied to the gates of the switching elements 1111a and 1112a. Similarly, the alternating-current conversion control signal 655b is supplied to the gates of the switching elements 1111b and 1112b. In the present embodiment, p-channel FETs are each used as the switching elements 1111a and 1111b, and n-channel FETs are used as the switching elements 1112a and 1112b.

Note that “a” and “b” attached to reference signs 655, 658, 1111, and 1112 correspond to the counter electrode terminals “a” and “b”, respectively, provided at the circulating pump 303.

The following describes operation of the alternating-current conversion circuit 607 illustrated in FIG. 11. Since the operation is common to sequence “a” and sequence “b”, the above-described “a” and “b” are omitted in the description.

In a case where the voltage of the alternating-current conversion control signal 655 is equal to the ground voltage of 0 V, the switching element 1111 is active and the switching element 1112 is opened. In this state, the drive voltage signal 657 is output as the pump drive signal 658 through the resistor 1110 and the switching element 1111. In a case where the alternating-current conversion control signal 655 is at the active voltage of 3.3 V, the switching element 1112 is active and the switching element 1111 is opened. In this state, the pump drive signal 658 is grounded through the switching element 1112. Since the voltages of the alternating-current conversion control signals 655a and 655b complementarily repeat the ground voltage and the active voltage of 3.3 V, the voltages of the pump drive signals 658a and 658b complementarily repeat the ground voltage and 72 V as the voltage of the drive voltage signal 657.

In this manner, what is called a full-bridge circuit can be used as the alternating-current conversion circuit 607 as described above.

### Fourth Embodiment

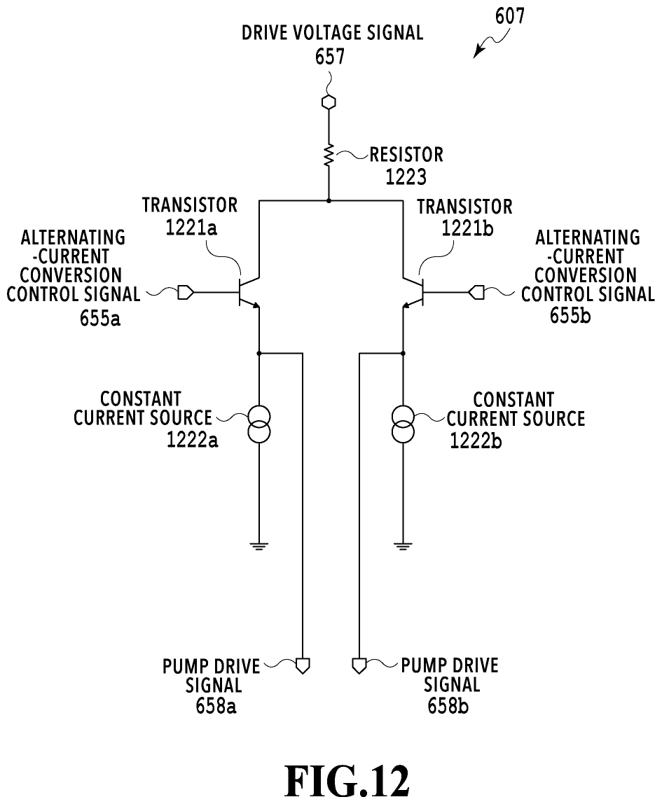

FIG. 12 is a circuit schematic diagram of the alternating-current conversion circuit 607 in a fourth embodiment. The drive voltage signal 657 having 72 V is supplied to the collectors of transistors 1221a and 1221b through a resistor 1223. In the present embodiment, NPN-type transistors are used as the transistors 1221a and 1221b. The alternating-current conversion control signal 655a is input to the base of the transistor 1221a. Similarly, the alternating-current conversion control signal 655b is input to the base of the transistor 1221b. The emitter of the transistor 1221a is connected to a constant current source 1222a. Similarly, the emitter of the transistor 1221b is connected to a constant current source 1222b. The pump drive signal 658a is output from the emitter of the transistor 1221a. Similarly, the pump drive signal 658b is output from the emitter of the transistor 1221b.

Note that “a” and “b” attached to reference signs 1221 and 1222 correspond to counter electrode terminals “a” and “b”, respectively, provided at the circulating pump 303.

The following describes operation of the alternating-current conversion circuit 607 illustrated in FIG. 12. Since the operation is common to sequence “a” and sequence “b”, the above-described “a” and “b” are omitted in the description.

In a case where the voltage of the alternating-current conversion control signal 655 is equal to the ground voltage of 0 V, the transistor 1221 is opened. In this state, the constant current source 1222 draws current from a signal line for the pump drive signal 658, and accordingly, the pump drive signal 658 decreases to the ground voltage. In a case where the alternating-current conversion control signal 655 is at the active voltage of 3.3 V, the transistor 1221 is active. In this state, current flows from a signal line for the drive voltage signal 657 into the constant current source 1222 and the signal line for the pump drive signal 658 through the resistor 1223 and the transistor 1221, and thus the drive voltage signal 657 is output as the pump drive signal 658. In this manner, the voltages of the alternating-current conversion control signals 655a and 655b complementarily repeat the ground voltage and the active voltage of 3.3 V, and accordingly, the voltages of the pump drive signals 658a and 658b complementarily repeat the ground voltage and 72 V as the voltage of the drive voltage signal 657.

As described above, what is called an A-class amplifier circuit can be used as the alternating-current conversion circuit 607.

### Fifth Embodiment

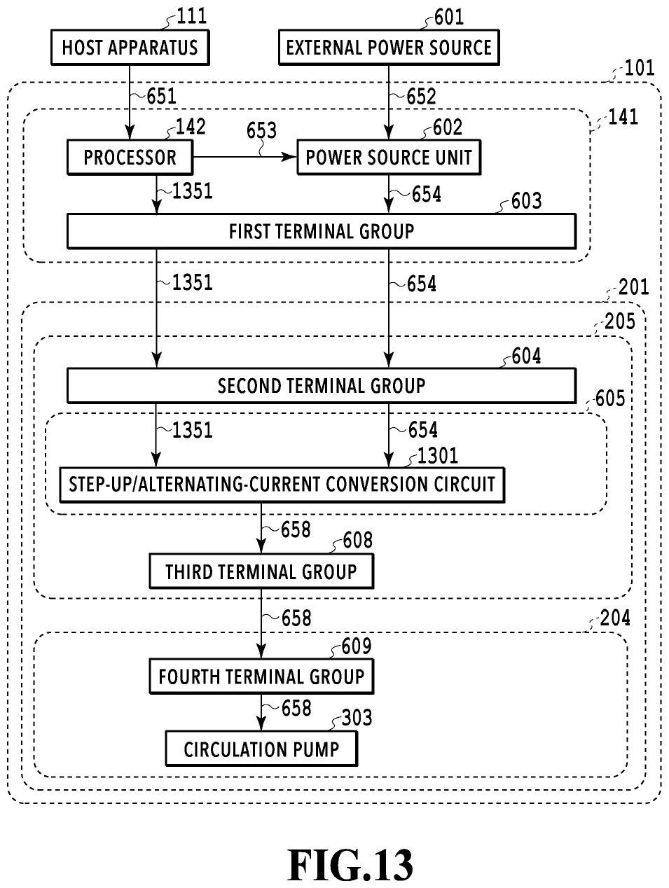

FIG. 13 is a configuration schematic diagram of the liquid discharge apparatus 101 according to a fifth embodiment. In the present embodiment, a reference voltage signal and a composite control signal 1351 are input to a step-up/alternating-current conversion circuit 1301. The pump drive signal 658 is output from the step-up/alternating-current conversion circuit 1301 to the third terminal group 608. The composite control signal 1351 includes 1351a and 1351b corresponding to the respective counter electrode terminals provided at the circulating pump 303. The other configuration is the same as in the first embodiment.

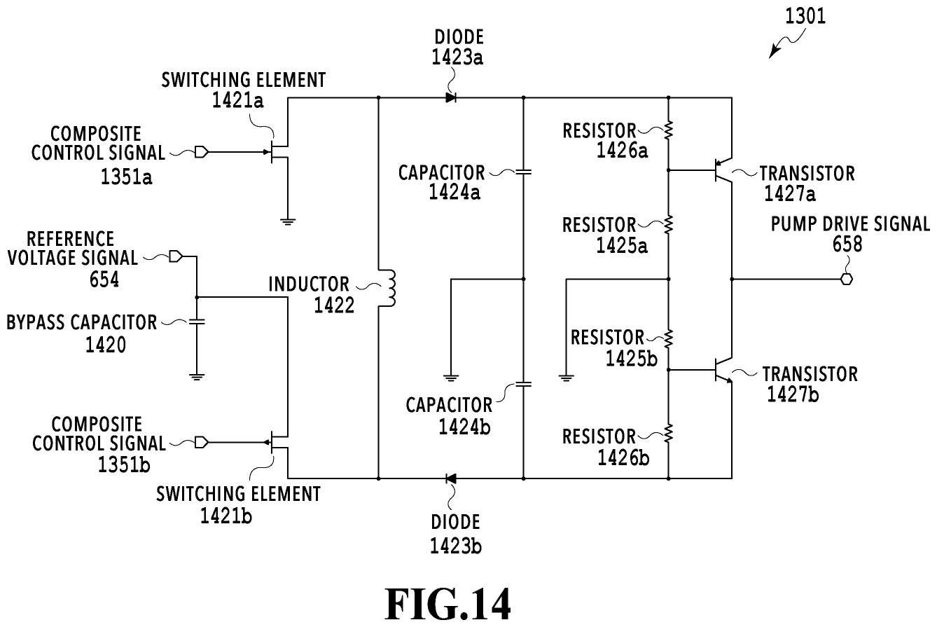

FIG. 14 is a circuit schematic diagram of the step-up/alternating-current conversion circuit 1301 according to the fifth embodiment. The step-up/alternating-current conversion circuit 1301 illustrated in FIG. 14 has a configuration in which a step-up chopper circuit on the positive side and a step-up chopper circuit on the negative side are integrated. The reference voltage signal 654 having 24 V is supplied to the drain of a switching element 1421b and the first terminal of a bypass capacitor 1420. In the present embodiment, n-channel field-effect transistors (FETs) are used as switching elements 1421a and 1421b. The source of the switching element 1421b is connected to the first terminal of an inductor 1422 and the cathode of a diode 1423b. The source of the switching element 1421a is grounded, and the drain thereof is connected to the second terminal of the inductor 1422 and the anode of a diode 1423a. The composite control signals 1351a and 1351b are supplied to the gates of the switching elements 1421a and 1421b, respectively. The cathode of the diode 1423a is connected to the first terminal of a capacitor 1424a, the first terminal of a resistor 1426a, and the emitter of a transistor 1427a. The anode of the diode 1423b is connected to the first terminal of a capacitor 1424b, the first terminal of a resistor 1426b, and the emitter of a transistor 1427b. The collectors of the transistors 1427a and 1427b are mutually connected, and the pump drive signal 658 is output from their connection point. In the present embodiment, a PNP-type transistor is used as the transistor 1427a, and an NPN-type transistor is used as the transistor 1427b.

The second terminals of the capacitors 1424a and 1424b are grounded. The second terminal of the resistor 1426a is connected to the first terminal of a resistor 1425a and the gate of the transistor 1427a. Similarly, the second terminal of the resistor 1426b is connected to the first terminal of a resistor 1425b and the gate of the transistor 1427b. The second terminals of the resistors 1425a and 1425b are grounded.

In a state in which the voltages of the composite control signals 1351a and 1351b are equal to the active voltage of 24 V, the switching elements 1421a and 1421b are active. Accordingly, current flows from the input terminal for the reference voltage signal 654 to the ground voltage through the switching element 1421b, the inductor 1422, and the switching element 1421a.

The switching element 1421a is switched off as the voltage of the composite control signal 1351a transitions from the active voltage to the ground voltage. However, since the inductor 1422 is positioned between a terminal for the reference voltage signal 654 and the ground voltage, electric charge flows into the capacitor 1424a through the diode 1423a by counter electromotive force generated at transition. Electric charge having flowed and accumulated in the capacitor 1424a cannot return to the anode side of the diode 1423a because of the diode 1423a. In this manner, electric charge flows and accumulates in the capacitor 1424a each time the composite control signal 1351a drives the switching element 1421a, and accordingly, the voltage of a terminal of the capacitor 1424a on the diode 1423a side is stepped up to voltage higher than the reference voltage signal 654. Such voltage is divided by the resistors 1426a and 1425a and input to the gate of the transistor 1427a. In a case where the voltage of the pump drive signal 658 is equal to the ground voltage, current flows from the gate of the transistor 1427a to the collector thereof due to voltage difference between the above-described divided voltage and the ground voltage. Accordingly, the transistor 1427a becomes active, and the stepped-up voltage is output from an output terminal for the pump drive signal 658. The composite control signal 1351a is driven so that the voltage of the pump drive signal 658 becomes equal to the pump drive voltage of 72 V.

Subsequently, the switching element 1421b is switched off when the voltage of the composite control signal 1351b transitions from the active voltage to the ground voltage from a state in which the composite control signals 1351a and 1351b are at the active voltage. However, since the inductor 1422 is positioned between the switching element 1421b and the ground voltage, electric charge flows out of the capacitor 1424b through the diode 1423b by counter electromotive force generated at transition. Electric charge having flowed out of the capacitor 1424b and accumulated cannot return to the cathode side of the diode 1423b because of the diode 1423b. In this manner, electric charge flows out of the capacitor 1424b and accumulates each time the composite control signal 1351b drives the switching element 1421b, and accordingly, a terminal of the capacitor 1424b on the diode 1423b side is stepped down to voltage lower than that of the reference voltage signal 654. Such voltage is divided by the resistors 1426b and 1425b and input to the gate of the transistor 1427b. In a case where the output terminal for the pump drive signal 658 is at voltage higher than the ground voltage, current flows from the collector of the transistor 1427b to the gate thereof due to voltage difference between the above-described divided voltage and the collector. Accordingly, the transistor 1427b becomes active, and the stepped-down voltage is output to the output terminal for the pump drive signal 658. The composite control signal 1351b is driven so that the voltage of the pump drive signal 658 becomes equal to −72 V.

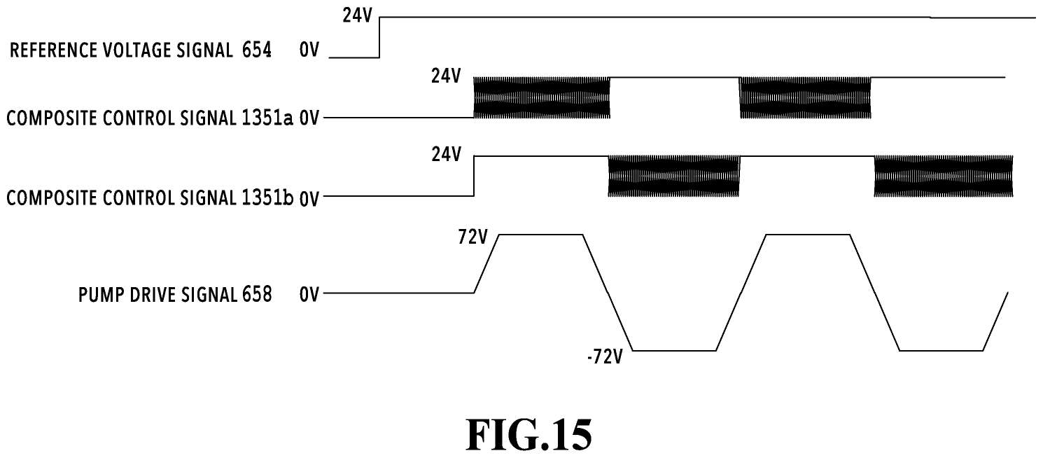

FIG. 15 is a timing chart illustrating operation of the pump drive circuit according to the fifth embodiment. First, the voltage of the reference voltage signal 654 transitions from the ground voltage of 0 V to 24 V.

Thereafter, the voltage of the composite control signal 1351b becomes equal to the active voltage of 24 V, and the voltage of the composite control signal 1351a transitions to the ground voltage of 0 V and the active voltage of 24 V in accordance with defined rules. With the transition of the composite control signal 1351a, the voltage of the pump drive signal 658 is stepped up from the ground voltage of 0 V to 72 V, which is voltage necessary for pump drive.

Thereafter, the voltage of the composite control signal 1351a becomes equal to the active voltage of 24 V, and the voltage of the composite control signal 1351b transitions to the ground voltage of 0 V and the active voltage of 24 V in accordance with defined rules. With the transition of the composite control signal 1351b, the voltage of the pump drive signal 658 is stepped-down from the ground voltage of 0 V to −72 V, which is voltage necessary for pump drive.

In this manner, as signal transitions of the composite control signals 1351a and 1351b are alternately switched, 72 V and −72 V, which are positive and negative voltages necessary for pump drive, are alternately output to the output terminal for the pump drive signal 658.

As described above, +72 V is output to the output terminal for the pump drive signal 658 as the alternating-current conversion control signal 655a repeats transition between the active voltage and the ground voltage while the alternating-current conversion control signal 655b is fixed active. When the alternating-current conversion control signals 655a and 655b are inverted, −72 V is output to the output terminal for the pump drive signal 658. It is possible to obtain the same pump drive capacity as the first embodiment by connecting one of the counter electrode terminals provided at the circulating pump 303 to the ground and supplying the pump drive signal 658 to the other.

### Sixth Embodiment

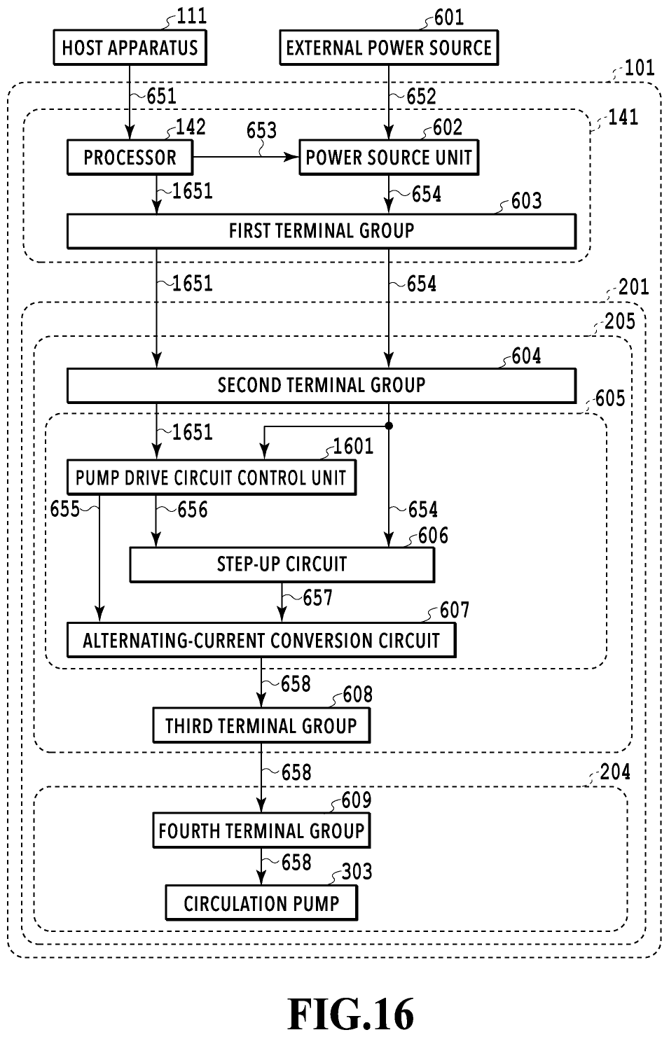

FIG. 16 is a configuration schematic diagram of the liquid discharge apparatus 101 according to a sixth embodiment. In the present embodiment, a pump drive circuit control signal 1651 is supplied from the processor 142 to a pump drive circuit control unit (also referred to as “control unit”) 1601 provided in the liquid discharge head 201. In accordance with the supply of the pump drive circuit control signal 1651, the pump drive circuit control unit 1601 supplies the step-up control signal 656 to the step-up circuit 606 and supplies the alternating-current conversion control signal 655 to the alternating-current conversion circuit 607. Note that the pump drive circuit control unit 1601 inputs the reference voltage signal 654 as well to achieve electric matching at the interface between the step-up circuit 606 and the alternating-current conversion circuit 607. The pump drive circuit control unit 1601 does not adjust drive voltage designated by the step-up control signal 656 with the voltage of the reference voltage signal 654. Thus, the pump drive circuit control unit 1601 designates, to the step-up circuit 606 by the step-up control signal 656, the same drive voltage as drive voltage designated by the pump drive circuit control signal 1651. In addition, the pump drive circuit control unit 1601 imparts, to the alternating-current conversion control signal 655, the same switching period as a switching period designated by the pump drive circuit control signal 1651.

Note that the step-up control signal 656 is, for example, a PWM signal the voltage of the drive voltage signal 657 output from the step-up circuit 606 can be adjusted by adjusting the duty of the step-up control signal 656 in accordance with the pump drive circuit control signal 1651.

In the present embodiment, a field programable gate array (FPGA) is used as the pump drive circuit control unit 1601. However, the pump drive circuit control unit 1601 may be configured in any manner with which the above-described functions can be achieved. For example, the pump drive circuit control unit 1601 may be configured as a circuit formed with discrete elements or may be configured as a programable logic device (PLD), a microcomputer, an application-specific integrated circuit (ASIC), or the like. The other configuration is the same as in the first embodiment.

When the pump drive circuit control unit 1601 is provided separately from the processor 142 in this manner, it is possible to control the pump drive circuit in accordance with a signal in a frequency band that any output port of the processor 142 does not support. For example, the step-up circuit 606 can be controlled with a signal in a frequency band that any output port of the processor 142 does not support. Moreover, the alternating-current conversion circuit 607 can be controlled by a signal in a frequency band that any output port of the processor 142 does not support. Thus, it is possible to achieve a configuration in which at least one of the step-up control signal 656 or the alternating-current conversion control signal 655 has a frequency band exceeding the frequency band of the pump drive circuit control signal 1651 output from the processor 142.

### Seventh Embodiment

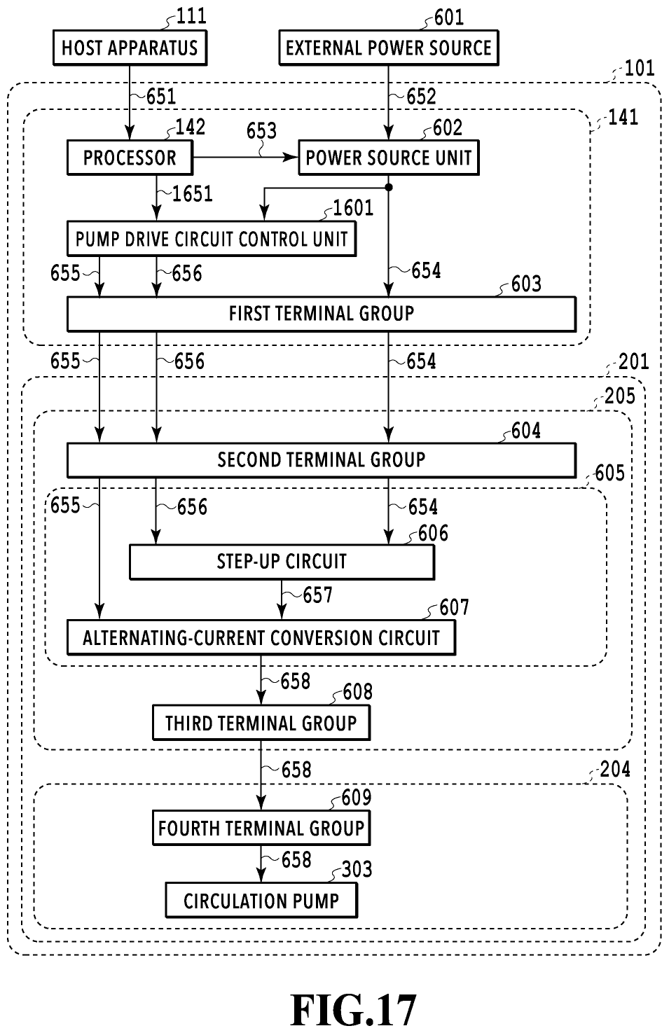

FIG. 17 is a configuration schematic diagram of the liquid discharge apparatus 101 according to a seventh embodiment. In the present embodiment, the pump drive circuit control signal 1651 is supplied from the processor 142 to the pump drive circuit control unit 1601 provided on the main board 141. In accordance with the supply of the pump drive circuit control signal 1651, the pump drive circuit control unit 1601 outputs the step-up control signal 656 to the step-up circuit 606 and the alternating-current conversion control signal 655 to the alternating-current conversion circuit 607 through the first terminal group 603 and the second terminal group 604. In the present embodiment, an FPGA is used as the pump drive circuit control unit 1601. The other configuration is the same as in the sixth embodiment.

In a case where the pump drive circuit control unit 1601 is provided on the main board 141 in this manner, the number of components in the liquid discharge head 201 can be reduced.

### Eighth Embodiment

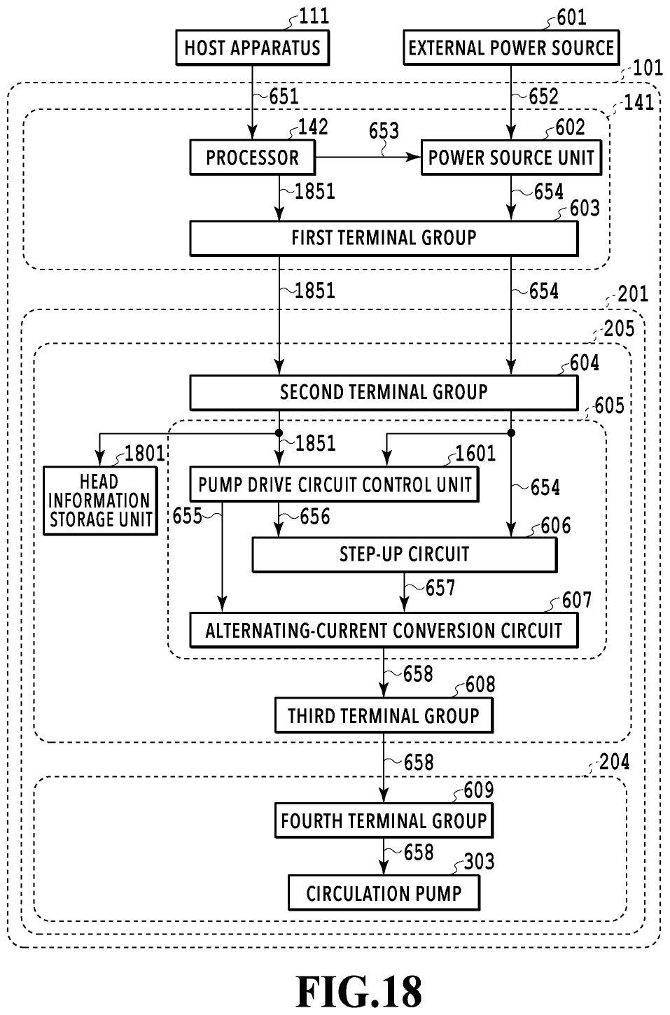

FIG. 18 is a configuration schematic diagram of the liquid discharge apparatus 101 according to an eighth embodiment. A head information storage unit 1801 is provided in the liquid discharge head 201. In the present embodiment, an electrically erasable programable read only memory (EEPROM) is used as the head information storage unit 1801, and an FPGA is used as the pump drive circuit control unit 1601. However, the head information storage unit 1801 may be configured in any manner with which functions as a storage unit can be achieved, and may be configured by using, for example, a mask ROM or a fuse ROM. The processor 142 supplies a head element control signal 1851 to the pump drive circuit control unit 1601 and the head information storage unit 1801. In the present embodiment, the head element control signal is compliant with an inter-integrated circuit (I2C) or (I²C) standard and constituted by a data line and a clock line. In the present embodiment, ICs compliant with the I2C standard are used as the head information storage unit 1801 and the pump drive circuit control unit 1601. With such a configuration, a common signal line can be used to control the head information storage unit 1801 and the pump drive circuit control unit 1601, and thus increase in the number of control signals can be suppressed. However, the head element control signal 1851 may include a signal for the head information storage unit 1801 and a signal for the pump drive circuit control unit 1601 as mutually independent signals. In the present embodiment, the pump drive circuit control unit 1601 reads pump drive condition information written to the head information storage unit 1801 and outputs the alternating-current conversion control signal 655 and the step-up control signal 656 in accordance with the information. For example, information designating the voltage of a drive voltage signal and information designating the frequency of a pump drive signal may be included in the pump drive condition information. In addition, for example, a plurality of pairs of information designating the voltage of the drive voltage signal and an index may be included in a pump drive condition signal. Then, the pump drive circuit control unit 1601 may read, from the head information storage unit 1801, the information designating the voltage of the drive voltage signal, which corresponds to an index transmitted from the processor 142. Similarly, for example, a plurality of pairs of information designating the frequency of the pump drive signal and an index may be included in the pump drive condition signal. Then, the pump drive circuit control unit 1601 may read, from the head information storage unit 1801, the information designating the frequency of the pump drive signal, which corresponds to an index transmitted from the processor 142.

With such a configuration, the processor 142 does not need to supply pump drive condition information to the pump drive circuit control unit 1601 at each pump drive, and thus the efficiency of transmission and reception of control signals can be increased. However, the pump drive circuit control unit 1601 may directly obtain the pump drive condition information from the head element control signal 1851 supplied from the processor 142.

### Ninth Embodiment

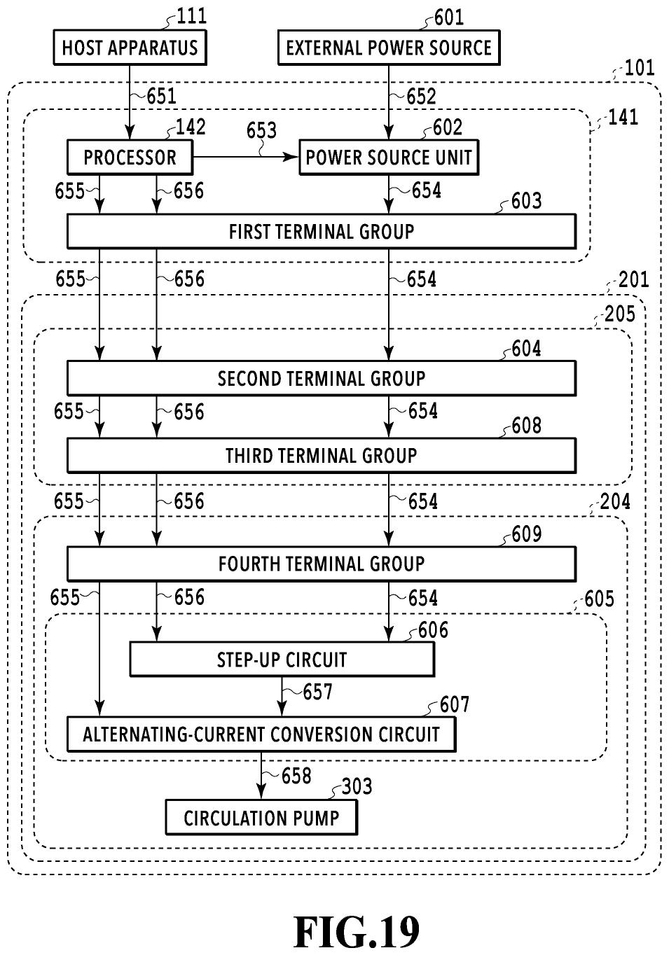

FIG. 19 is a configuration schematic diagram of the liquid discharge apparatus 101 according to a ninth embodiment. In the present embodiment, the step-up circuit 606 and the alternating-current conversion circuit 607 are provided in each liquid circulation unit 204. The other configuration is the same as in the first embodiment.

With such a configuration, it is possible to suppress wiring lengths of the drive voltage signal 657 and the pump drive signal 658, which are high voltages. Moreover, the same effects can be achieved with a configuration in which the alternating-current conversion circuit 607 is provided in each liquid circulation unit 204 and the step-up circuit 606 is provided at part of the liquid discharge head 201 other than the liquid circulation units 204.

### Tenth Embodiment

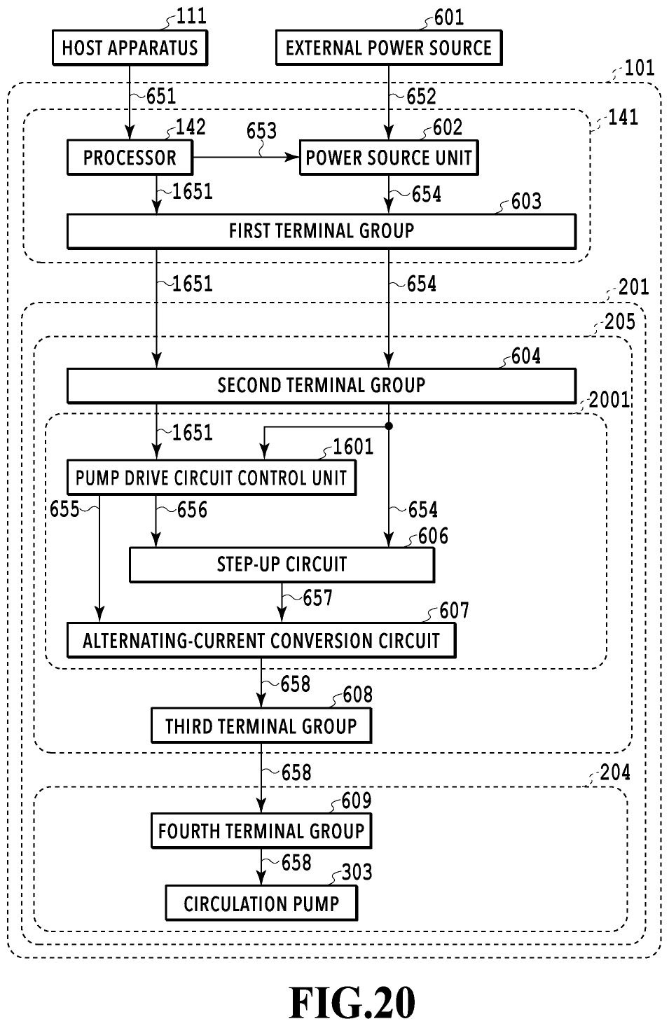

FIG. 20 is a configuration schematic diagram of the liquid discharge apparatus 101 according to a tenth embodiment. In the present embodiment, the pump drive circuit control unit 1601, the step-up circuit 606, and the alternating-current conversion circuit 607 are included in one package IC 2001 mounted on the electric circuit board 205. The other configuration is the same as in the sixth embodiment.

With such a configuration, the area of the pump drive circuit can be reduced. The same effects can be achieved with a configuration in which not all of sub some of the pump drive circuit control unit 1601, the step-up circuit 606, and the alternating-current conversion circuit 607 are included in one package IC 2001.

### Eleventh Embodiment

In a case where the step-up circuit 606 mounted on the liquid discharge head 201 has failed, excessive step-up potentially occurs and adversely affects peripheral components due to anomaly operation or the like. The present embodiment provides a configuration for preventing anomalous step-up due to step-up circuit failure.

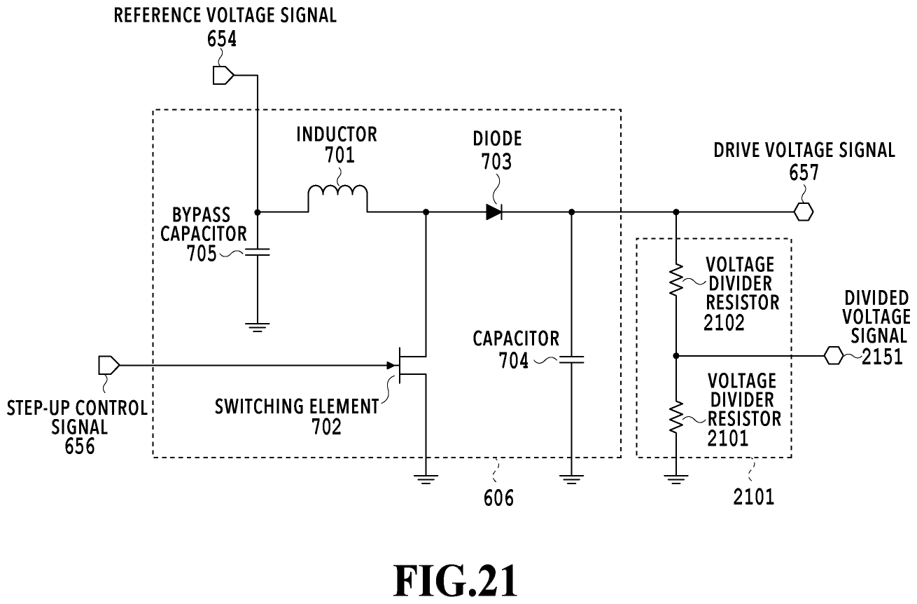

FIG. 21 is a circuit schematic diagram of the step-up circuit and a voltage divider circuit. The step-up circuit 606 illustrated in FIG. 21 is the same as that illustrated in FIG. 7, which is described above in the first embodiment and thus any duplicate description is omitted. A voltage divider circuit 2101 divides the voltage of the drive voltage signal 657 by voltage divider resistors 2102 and 2103 connected in series and outputs a divided voltage signal (also referred to as “voltage sensing signal”) 2151 having the divided voltage.

In the present embodiment, the step-up control signal 656 is input to the switching element 702 so that the drive voltage signal 657 having a voltage of 72 V is generated based on the reference voltage signal 654 having a voltage of 24 V. The voltage divider circuit 2101 outputs the divided voltage signal 2151 having a voltage equal to 1/20 approximately of the voltage of the drive voltage signal 657.

### Description of Operation at Excessive Step-Up Detection

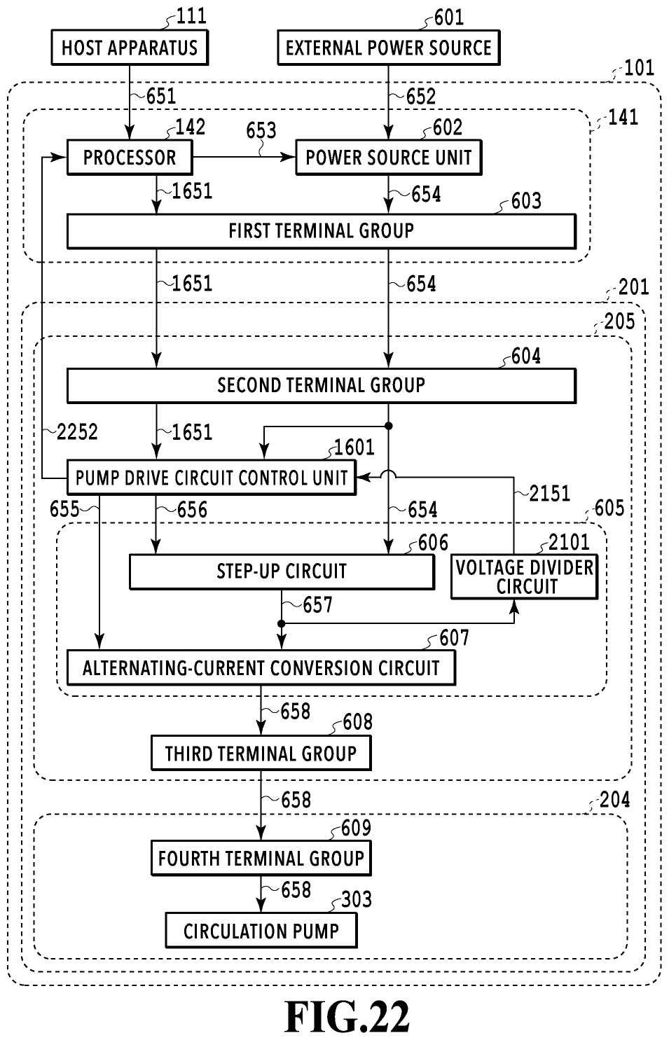

FIG. 22 is a configuration schematic diagram of the liquid discharge apparatus 101 according to an eleventh embodiment. The voltage divider circuit 2101 is included in the pump drive circuit 605. The voltage divider circuit 2101 divides the drive voltage signal 657 output from the step-up circuit 606 and outputs the divided voltage signal 2151 having the divided voltage. The pump drive circuit control unit 1601 performs control to be described later based on the divided voltage signal 2151. The other configuration is the same as in the sixth embodiment, and thus any duplicate description is omitted. Note that the circuit as illustrated in FIG. 7 or FIG. 10 can be used as the step-up circuit 606. The step-up circuit 606 and the alternating-current conversion circuit 607 may be replaced with the step-up/alternating-current conversion circuit 1301 illustrated in FIG. 14.

In a case of having detected that the voltage of the drive voltage signal 657 has exceeded maximum allowable voltage (for example, 80 V), the pump drive circuit control unit 1601 performs control for decreasing the voltage of the drive voltage signal 657. The control is, for example, to stop the step-up control signal 656 or to decrease or set to 0 V pump drive voltage designated by the step-up control signal 656. Accordingly, a switching element included in the step-up circuit 606 or the step-up/alternating-current conversion circuit 1301 can be stopped or the voltage of the drive voltage signal 657 or the pump drive signal 658 output from the step-up circuit 606 or the step-up/alternating-current conversion circuit 1301 can be decreased.

The control may include controlling the processor 142 by a processor control signal 2252 to adjust the pump drive circuit control signal 1651 or the power source control signal 653. The adjustment includes, for example, changing pump drive voltage designated by the pump drive circuit control signal 1651 to low voltage or 0 V. The adjustment also includes setting the power source control signal 653 to be inactive. Accordingly, the voltage of the reference voltage signal 654 output from the power source unit 602 becomes 0 V. Thus, the pump drive circuit control unit 1601 can stop the step-up circuit 606 by intervening the designation of the voltage of the pump drive signal 658 by the processor 142 of the liquid discharge apparatus 101. Moreover, the pump drive circuit control unit 1601 can decrease or set to 0 V the voltage of the drive voltage signal 657 output from the step-up circuit 606 by intervening the designation of the voltage of the pump drive signal 658 by the processor 142 of the liquid discharge apparatus 101.

Note that the divided voltage signal 2151 may be used to feedback-control the voltage of the drive voltage signal 657 in normal operation. Specifically, voltage instructed by the step-up control signal 656 may be changed based on the difference of the actual voltage of the drive voltage signal 657, which is indicated by the divided voltage signal 2151, from voltage instructed by the pump drive circuit control signal 1651. The step-up control signal 656 is, for example, a PWM signal and the voltage of the drive voltage signal 657 output from the step-up circuit 606 can be adjusted by adjusting the duty of the step-up control signal 656 in accordance with the difference. Specifically, the voltage instructed by the step-up control signal 656 is decreased in a case where the actual voltage of the drive voltage signal 657, which is indicated by the divided voltage signal 2151, is higher than the voltage instructed by the pump drive circuit control signal 1651. For example, the duty of the step-up control signal 656 is decreased. The voltage instructed by the step-up control signal 656 is increased in a case where the actual voltage of the drive voltage signal 657, which is indicated by the divided voltage signal 2151, is lower than the voltage instructed by the pump drive circuit control signal 1651. For example, the duty of the step-up control signal 656 is increased. Moreover, a dead-band voltage range may be provided in this feedback control. Specifically, the feedback control is not performed in a case where the voltage of the drive voltage signal 657 is in a predetermined voltage range, and the feedback control may be performed in a case where the voltage of the drive voltage signal 657 deviates from the predetermined voltage range. A target voltage in this case may be selected from the predetermined voltage range as appropriate. The target voltage may be, for example, the center voltage of the predetermined voltage range. With the feedback control, the more stable pump drive signal 658 can be supplied to the circulation pump 303.

### Twelfth Embodiment

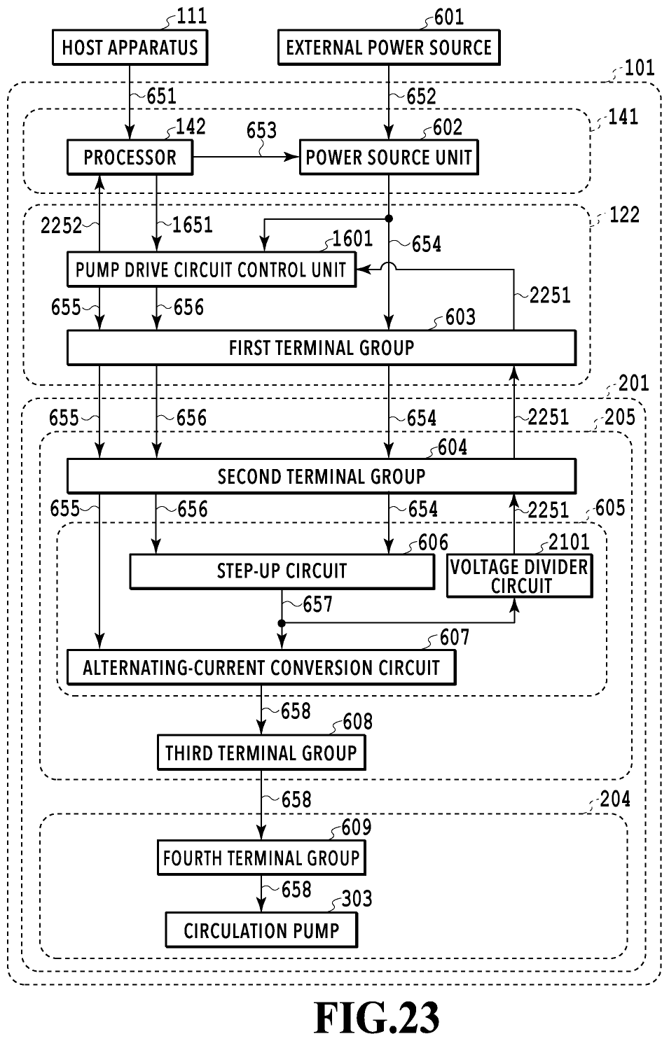

FIG. 23 is a configuration schematic diagram of the liquid discharge apparatus 101 according to a twelfth embodiment. The present embodiment is different from the eleventh embodiment in that the disposition place of the pump drive circuit control unit 1601 is changed from the electric circuit board 205 to the carriage board 122, but has no other change. Thus, in the present embodiment, the step-up circuit 606 and the voltage divider circuit 2101 are mounted on the electric circuit board 205, and the pump drive circuit control unit 1601 is mounted on the carriage board 122.

According to the present embodiment, circuits included in the electric circuit board 205 are simplified. In a case where an electric examination is performed in a process of manufacturing the liquid discharge head 201, the rate of defect occurrence due to the electric circuit board 205 decreases because of the simplification of circuits included in the electric circuit board 205, and as a result, productivity of the liquid discharge head 201 is expected to improve. The productivity improvement is meaningful in a system in which the liquid discharge head 201 is a replaceable component, in particular.

Note that the divided voltage signal 2151 is returned to the carriage board 122 from the electric circuit board 205, and an output signal from the pump drive circuit control unit 1601 is supplied to the electric circuit board 205 from the carriage board 122. Since the carriage board 122 and the electric circuit board 205 are contact-connected at the electrical connection part 504 as illustrated in FIG. 5, the signal quality of signals across the boards 122 and 205 is ensured.

### Thirteenth Embodiment

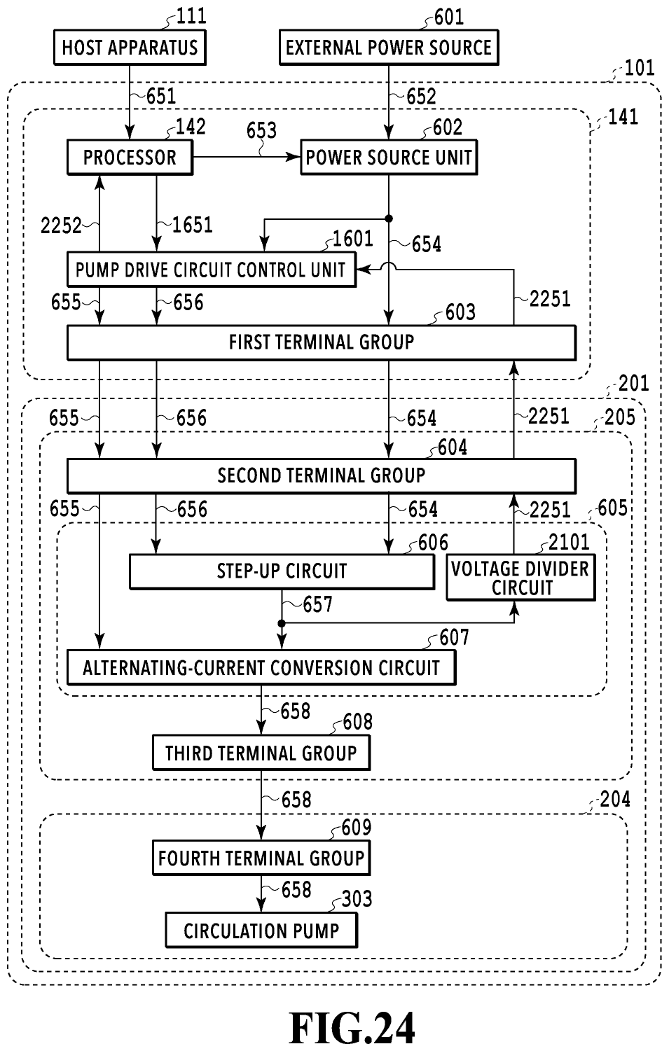

FIG. 24 is a configuration schematic diagram of the liquid discharge apparatus 101 according to a thirteenth embodiment. The present embodiment is different from the eleventh embodiment in that the disposition place of the pump drive circuit control unit 1601 is changed from the electric circuit board 205 to the main board 141, but has no other change. Thus, in the present embodiment, the step-up circuit 606 and the voltage divider circuit 2101 are mounted on the electric circuit board 205, and the pump drive circuit control unit 1601 is mounted on the main board 141.

In a case of a scanning-type liquid discharge head, the sizes of the liquid discharge head 201 and the carriage 121 are likely to affect the apparatus size, and space constraints often exist. With the configuration of the present embodiment, the liquid discharge head 201 and the carriage 121 can be downsized since the pump drive circuit control unit 1601 is disposed in none of the liquid discharge head 201 and the carriage 121. Moreover, the productivity of the liquid discharge head 201 can be improved as in the twelfth embodiment.

### Fourteenth Embodiment

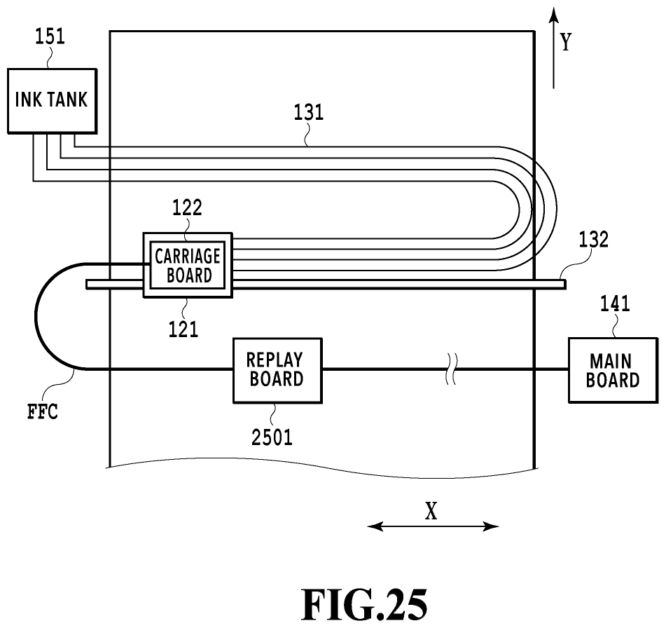

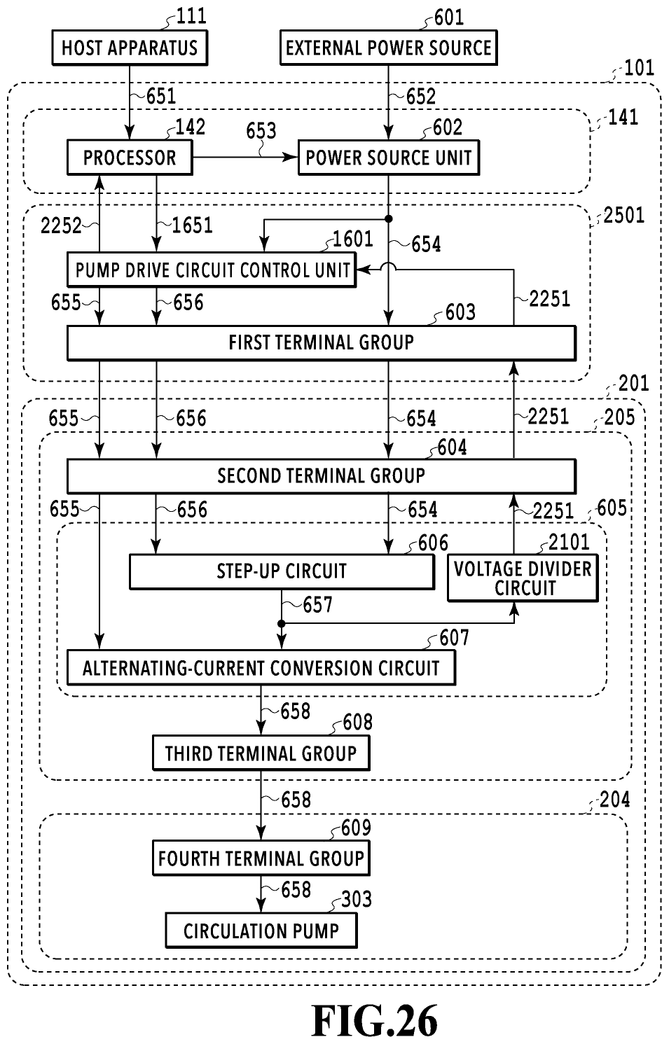

FIG. 25 is a configuration diagram of a main part of the liquid discharge apparatus 101 according to a fourteenth embodiment, and FIG. 26 is a configuration schematic diagram of the liquid discharge apparatus 101 according to the fourteenth embodiment.

In the present embodiment, a relay board 2501 is inserted between the carriage board 122 and the main board 141 mounted on the carriage 121. In a liquid discharge apparatus designed for personal and office use, the carriage board 122 and the main board 141 are typically directly connected to each other through an FFC. However, in an apparatus for large-format output such as posters, the scanning range of a liquid discharge head may be large, and the FFC may be long with the above-described configuration, which may potentially degrade the signal quality. As a measure against this, the relay board 2501 can be inserted between the carriage board 122 and the main board 141 to prevent signal quality degradation. In the present embodiment, the pump drive circuit control unit 1601 is mounted on the relay board 2501 as illustrated in FIG. 26.

With this configuration, as in the thirteenth embodiment, downsizing design is possible and the productivity of the liquid discharge head 201 can be improved.

### Fifteenth Embodiment

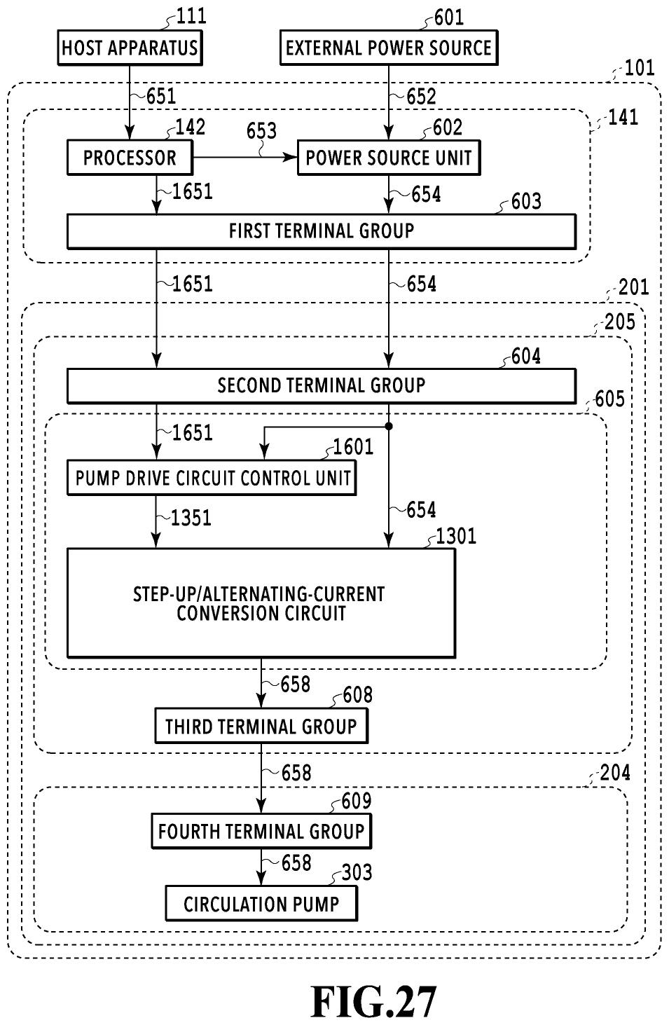

Just as the sixth embodiment illustrated in FIG. 16 is derived from the configuration of the first embodiment illustrated in FIG. 6, a fifteenth embodiment as illustrated in FIG. 27 may be derived from the configuration of the fifth embodiment illustrated in FIG. 13. In this case, the pump drive circuit control unit 1601 does not generate the step-up control signal 656 nor the alternating-current conversion control signal 655 but generates the composite control signal 1351. In other words, the pump drive circuit control unit 1601 according to the fifteenth embodiment generates the composite control signal 1351 based on a pump drive circuit control signal and supplies the generated composite control signal 1351 to the step-up/alternating-current conversion circuit 1301.

### Sixteenth Embodiment

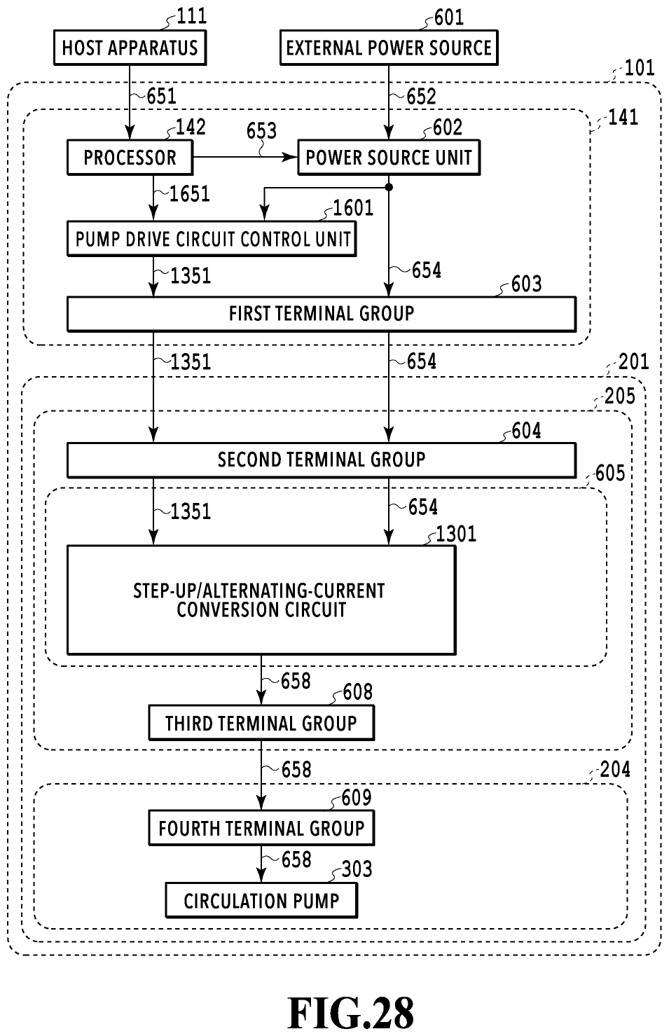

Just as the seventh embodiment illustrated in FIG. 17 is derived from the configuration of the first embodiment illustrated in FIG. 6, a sixteenth embodiment as illustrated in FIG. 28 may be derived from the configuration of the fifth embodiment illustrated in FIG. 13. In this case, the pump drive circuit control unit 1601 does not generate the step-up control signal 656 nor the alternating-current conversion control signal 655 but generates the composite control signal 1351. In other words, the pump drive circuit control unit 1601 according to the fifteenth embodiment generates the composite control signal 1351 based on a pump drive circuit control signal and supplies the generated composite control signal 1351 to the step-up/alternating-current conversion circuit 1301 through the first terminal group 603 and the second terminal group 604.

### Seventeenth Embodiment

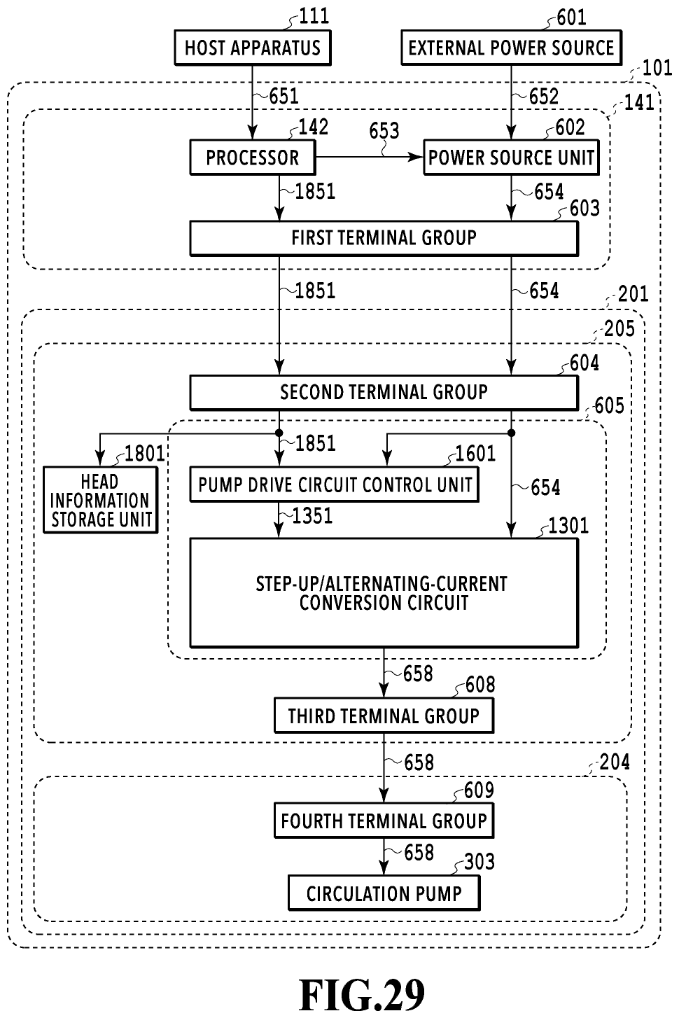

Just as the eighth embodiment illustrated in FIG. 18 is derived from the configuration of the first embodiment illustrated in FIG. 6, a seventeenth embodiment as illustrated in FIG. 29 may be derived from the configuration of the fifth embodiment illustrated in FIG. 13. In this case, the pump drive circuit control unit 1601 does not generate the step-up control signal 656 nor the alternating-current conversion control signal 655 but generates the composite control signal 1351. In other words, the pump drive circuit control unit 1601 according to the fifteenth embodiment generates the composite control signal 1351 based on a pump drive circuit control signal and supplies the generated composite control signal 1351 to the step-up/alternating-current conversion circuit 1301.

### Eighteenth Embodiment

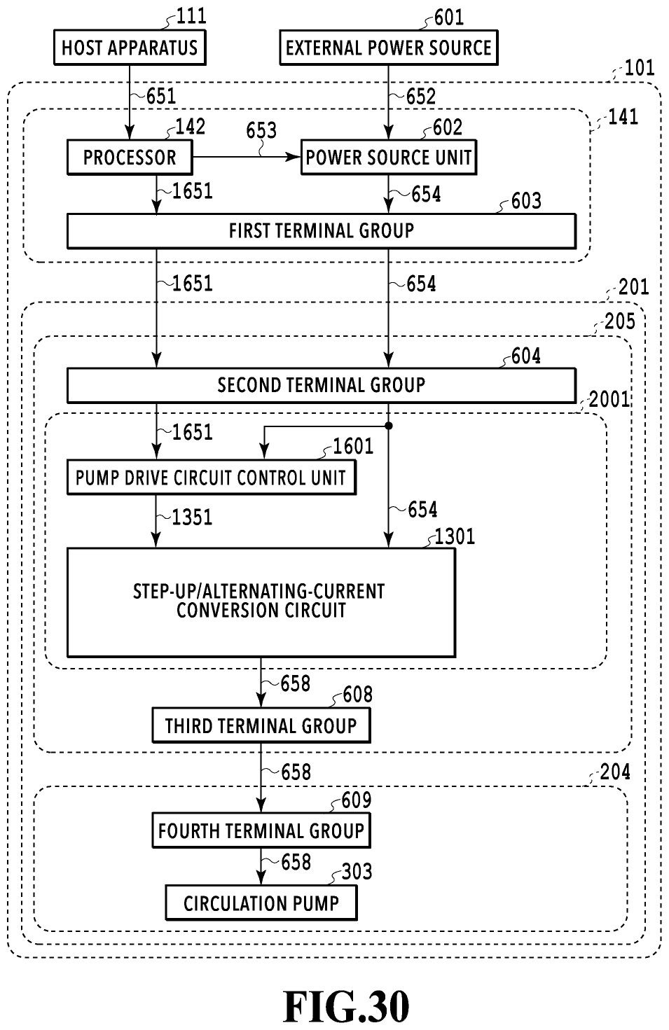

Just as the tenth embodiment illustrated in FIG. 20 is derived from the configuration of the first embodiment illustrated in FIG. 6, an eighteenth embodiment as illustrated in FIG. 30 may be derived from the configuration of the fifth embodiment illustrated in FIG. 13. In this case, the pump drive circuit control unit 1601 does not generate the step-up control signal 656 nor the alternating-current conversion control signal 655 but generates the composite control signal 1351. In other words, the pump drive circuit control unit 1601 according to the fifteenth embodiment generates the composite control signal 1351 based on a pump drive circuit control signal and supplies the generated composite control signal 1351 to the step-up/alternating-current conversion circuit 1301.

### Nineteenth Embodiment

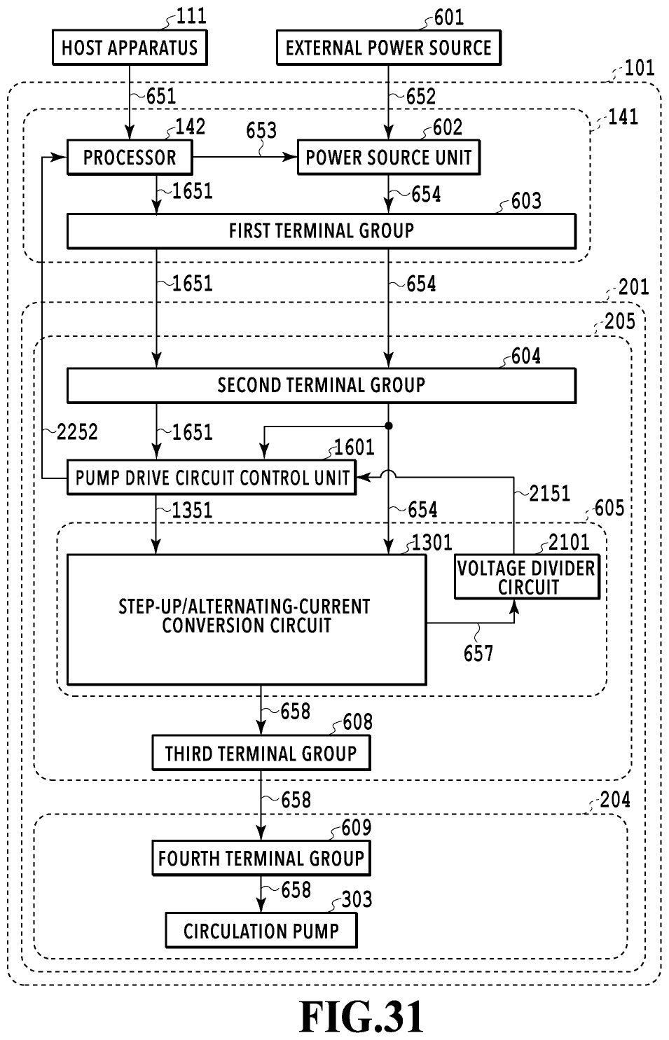

Just as the eleventh embodiment illustrated in FIG. 22 is derived from the configuration of the first embodiment illustrated in FIG. 6, a nineteenth embodiment as illustrated in FIG. 31 may be derived from the configuration of the fifth embodiment illustrated in FIG. 13. In this case, the pump drive circuit control unit 1601 does not generate the step-up control signal 656 nor the alternating-current conversion control signal 655 but generates the composite control signal 1351. In other words, the pump drive circuit control unit 1601 according to the fifteenth embodiment generates the composite control signal 1351 based on a pump drive circuit control signal and supplies the generated composite control signal 1351 to the step-up/alternating-current conversion circuit 1301. The signal 657 input to the voltage divider circuit 2101 is a signal indicating the voltage of the pump drive signal. The signal can be obtained by, for example, dividing the peak-to-peak voltage of the pump drive signal. This is the same for twentieth to twenty-second embodiments to be described later.

### Twentieth Embodiment

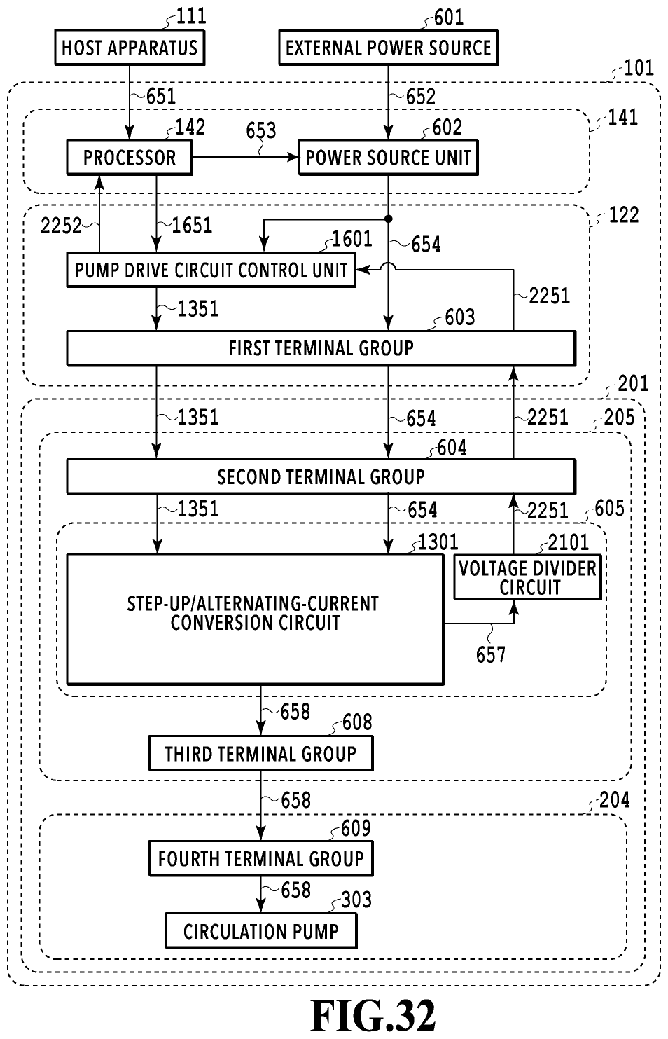

Just as the twelfth embodiment illustrated in FIG. 23 is derived from the configuration of the first embodiment illustrated in FIG. 6, the twentieth embodiment as illustrated in FIG. 32 may be derived from the configuration of the fifth embodiment illustrated in FIG. 13. In this case, the pump drive circuit control unit 1601 does not generate the step-up control signal 656 nor the alternating-current conversion control signal 655 but generates the composite control signal 1351. In other words, the pump drive circuit control unit 1601 according to the fifteenth embodiment generates the composite control signal 1351 based on a pump drive circuit control signal and supplies the generated composite control signal 1351 to the step-up/alternating-current conversion circuit 1301 through the first terminal group 603 and the second terminal group 604.

### Twenty-First Embodiment

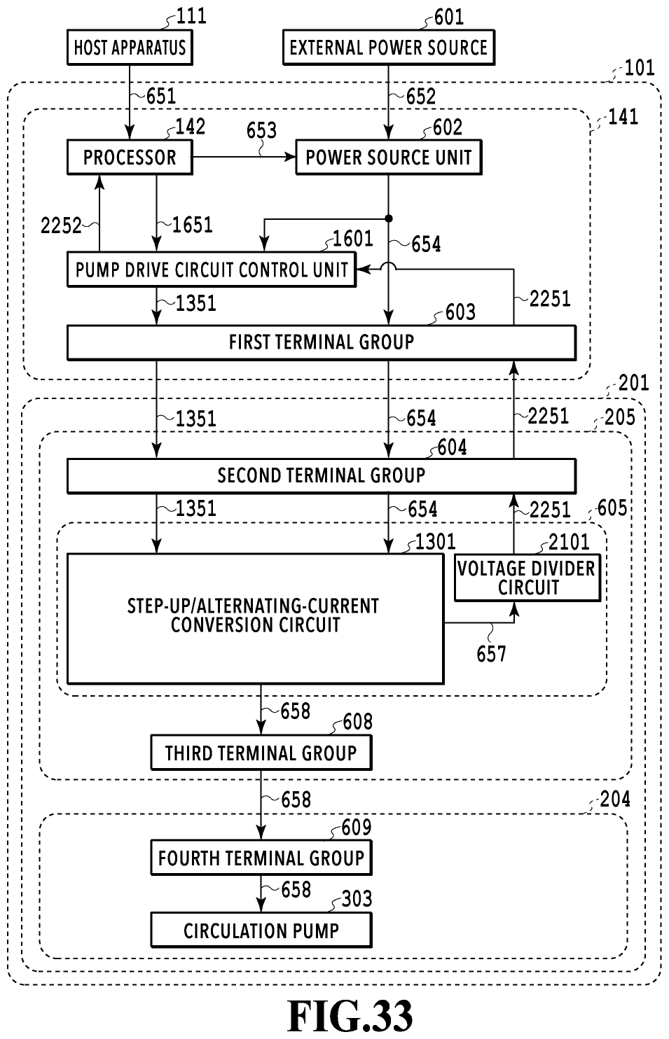

Just as the thirteenth embodiment illustrated in FIG. 24 is derived from the configuration of the first embodiment illustrated in FIG. 6, the twenty-first embodiment as illustrated in FIG. 33 may be derived from the configuration of the fifth embodiment illustrated in FIG. 13. In this case, the pump drive circuit control unit 1601 does not generate the step-up control signal 656 nor the alternating-current conversion control signal 655 but generates the composite control signal 1351. In other words, the pump drive circuit control unit 1601 according to the fifteenth embodiment generates the composite control signal 1351 based on a pump drive circuit control signal and supplies the generated composite control signal 1351 to the step-up/alternating-current conversion circuit 1301.

### Twenty-Second Embodiment

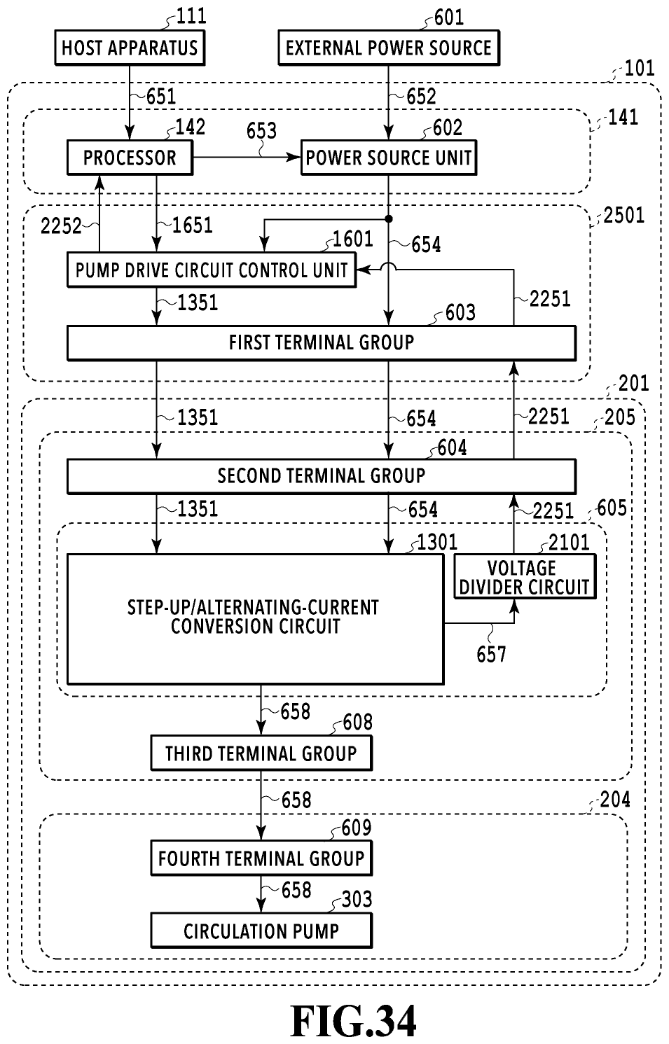

Just as the fourteenth embodiment illustrated in FIG. 26 is derived from the configuration of the first embodiment illustrated in FIG. 6, the twenty-second embodiment as illustrated in FIG. 34 may be derived from the configuration of the fifth embodiment illustrated in FIG. 13. In this case, the pump drive circuit control unit 1601 does not generate the step-up control signal 656 nor the alternating-current conversion control signal 655 but generates the composite control signal 1351. In other words, the pump drive circuit control unit 1601 according to the fifteenth embodiment generates the composite control signal 1351 based on a pump drive circuit control signal and supplies the generated composite control signal 1351 to the step-up/alternating-current conversion circuit 1301 through the first terminal group 603 and the second terminal group 604.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priority from Japanese Patent Application No. 2023-203996, filed Dec. 1, 2023, which is hereby incorporated by reference wherein in its entirety.

What is claimed is:

1. A liquid discharge head comprising:
a discharge unit configured to discharge liquid inside a pressure chamber;
a supply flow path through which liquid to be supplied to the pressure chamber flows;
a collection flow path that is connected to the supply flow path through the pressure chamber and through which liquid collected from the pressure chamber flows;
a circulating pump capable of supplying liquid to the pressure chamber through the supply flow path, collecting liquid from the pressure chamber through the collection flow path, and recirculating collected liquid to the supply flow path based on an alternating-current pump drive signal; and
a pump drive circuit configured to generate the pump drive signal by stepping up and converting to alternating current a direct-current reference voltage signal having voltage lower than the peak-to-peak voltage of the pump drive signal.

2. The liquid discharge head according to claim 1, wherein the pump drive circuit includes
a step-up circuit configured to generate a direct-current drive voltage signal by stepping up the reference voltage signal, and
an alternating-current conversion circuit configured to generate the pump drive signal by converting the drive voltage signal to alternating current.

3. The liquid discharge head according to claim 2, wherein the step-up circuit generates the drive voltage signal by stepping up the reference voltage signal based on a step-up control signal for controlling the step-up circuit.

4. The liquid discharge head according to claim 2, wherein the alternating-current conversion circuit generates the pump drive signal by converting the drive voltage signal to alternating current based on an alternating-current conversion control signal for controlling the alternating-current conversion circuit.

5. The liquid discharge head according to claim 2, wherein
the step-up circuit generates the drive voltage signal by stepping up the reference voltage signal based on a step-up control signal for controlling the step-up circuit,
the alternating-current conversion circuit generates the pump drive signal by converting the drive voltage signal to alternating current based on an alternating-current conversion control signal for controlling the alternating-current conversion circuit, and
the liquid discharge head further includes a control unit configured to generate the step-up control signal and the alternating-current conversion control signal based on a pump drive circuit control signal.

6. The liquid discharge head according to claim 5, wherein
the pump drive circuit control signal includes information designating the voltage of the drive voltage signal, and
the control unit adjusts the step-up control signal so that the drive voltage signal has the voltage designated by the pump drive circuit control signal.

7. The liquid discharge head according to claim 5, wherein
the pump drive circuit control signal includes information designating the voltage of the drive voltage signal,
the liquid discharge head further includes a circuit configured to generate a voltage sensing signal indicating the voltage of the drive voltage signal, and
the control unit adjusts the step-up control signal so that the voltage of the drive voltage signal, which is indicated by the voltage sensing signal becomes equal to the voltage designated by the pump drive circuit control signal.

8. The liquid discharge head according to claim 5, wherein
the pump drive circuit control signal includes information designating the period of the alternating-current conversion control signal, and
the control unit imparts a period in accordance with the designation by the pump drive circuit control signal to the alternating-current conversion control signal.

9. The liquid discharge head according to claim 5, further comprising a circuit configured to generate a voltage sensing signal indicating the voltage of the drive voltage signal, wherein in a case where the voltage of the drive voltage signal, which is indicated by the voltage sensing signal has exceeded maximum allowable voltage, the control unit sets the voltage of the drive voltage signal generated by the step-up circuit to be lower than the maximum allowable voltage or to be 0 V by adjusting the step-up control signal.

10. The liquid discharge head according to claim 5, further comprising a circuit configured to generate a voltage sensing signal indicating the voltage of the drive voltage signal, wherein
the voltage of the drive voltage signal is designated by a liquid discharge apparatus on which the liquid discharge head is mounted, and
in a case where the voltage of the drive voltage signal, which is indicated by the voltage sensing signal has exceeded maximum allowable voltage, the control unit sets the voltage of the drive voltage signal generated by the step-up circuit to be lower than the maximum allowable voltage or to be 0 V by intervening the designation of the voltage of the drive voltage signal by the liquid discharge apparatus.

11. The liquid discharge head according to claim 5, further comprising a storage unit storing pump drive condition information, wherein the control unit refers to the pump drive condition information stored in the storage unit.

12. The liquid discharge head according to claim 5, wherein at least one of the step-up control signal and the alternating-current conversion control signal has a frequency band exceeding the frequency band of the pump drive circuit control signal.

13. The liquid discharge head according to claim 1, wherein the pump drive circuit generates the pump drive signal by stepping up and converting to alternating current the reference voltage signal based on a composite control signal for controlling the pump drive circuit.

14. The liquid discharge head according to claim 13, wherein the liquid discharge head further includes a control unit configured to generate the composite control signal based on a pump drive circuit control signal.

15. The liquid discharge head according to claim 14, wherein
the composite control signal includes information designating the voltage of the pump drive signal, and
the control unit adjusts the composite control signal so that the pump drive signal has the voltage designated by the pump drive circuit control signal.

16. The liquid discharge head according to claim 14, wherein
the composite control signal includes information designating the voltage of the pump drive signal,
the liquid discharge head further includes a circuit configured to generate a voltage sensing signal indicating the voltage of the pump drive signal, and
the control unit adjusts the composite control signal so that the voltage of the pump drive signal, which is indicated by the voltage sensing signal becomes equal to the voltage designated by the pump drive circuit control signal.

17. The liquid discharge head according to claim 14, wherein
the pump drive circuit control signal includes information designating the period of the composite control signal, and
the control unit imparts a period in accordance with the designation by the pump drive circuit control signal to the composite control signal.

18. The liquid discharge head according to claim 14, further comprising a circuit configured to generate a voltage sensing signal indicating the voltage of the pump drive signal, wherein in a case where the voltage of the pump drive signal, which is indicated by the voltage sensing signal has exceeded maximum allowable voltage, the control unit sets the voltage of the pump drive signal generated by the pump drive circuit to be lower than the maximum allowable voltage or to be 0 V by adjusting the composite control signal.

19. The liquid discharge head according to claim 14, further comprising a circuit configured to generate a voltage sensing signal indicating the voltage of the pump drive signal, wherein
the voltage of the pump drive signal is designated by a liquid discharge apparatus on which the liquid discharge head is mounted, and
in a case where the voltage of the pump drive signal, which is indicated by the voltage sensing signal has exceeded maximum allowable voltage, the control unit sets the voltage of the pump drive signal generated by the pump drive circuit to be lower than the maximum allowable voltage or to be 0 V by intervening the designation of the voltage of the pump drive signal by the liquid discharge apparatus.

20. The liquid discharge head according to claim 14, further comprising a storage unit storing pump drive condition information, wherein the control unit refers to the pump drive condition information stored in the storage unit.

21. The liquid discharge head according to claim 14, wherein the composite control signal has a frequency band exceeding the frequency band of the pump drive circuit control signal.

22. The liquid discharge head according to claim 1, further comprising:
a circuit configured to generate a voltage sensing signal indicating the voltage of the pump drive signal; and
a control unit configured to control the pump drive circuit based on the voltage sensing signal.

23. The liquid discharge head according to claim 22, wherein the control unit stops the pump drive circuit in a case where the voltage of the pump drive signal, which is indicated by the voltage sensing signal has exceeded maximum allowable voltage.

24. The liquid discharge head according to claim 1, further comprising:
a first pressure adjustment unit disposed between an exit of the circulating pump and an entrance of the supply flow path and configured to adjust the pressure of liquid at the entrance of the supply flow path; and
a second pressure adjustment unit disposed between an entrance of the circulating pump and an exit of the collection flow path and configured to adjust pressure at the exit of the collection flow path.

25. A liquid discharge apparatus comprising:
a liquid discharge head including
a discharge unit configured to discharge liquid inside a pressure chamber,
a supply flow path through which liquid to be supplied to the pressure chamber flows,
a collection flow path that is connected to the supply flow path through the pressure chamber and through which liquid collected from the pressure chamber flows,
a circulating pump capable of supplying liquid to the pressure chamber through the supply flow path, collecting liquid from the pressure chamber through the collection flow path, and recirculating collected liquid to the supply flow path based on an alternating-current pump drive signal,
a step-up circuit configured to generate a direct-current drive voltage signal by stepping up a reference voltage signal having voltage lower than the peak-to-peak voltage of the pump drive signal based on a step-up control signal for controlling the step-up circuit, and
an alternating-current conversion circuit configured to generate the pump drive signal by converting the drive voltage signal to alternating current based on an alternating-current conversion control signal for controlling the alternating-current conversion circuit; and
a control unit configured to generate the alternating-current conversion control signal and the step-up control signal based on a pump drive circuit control signal.

26. The liquid discharge apparatus according to claim 25, wherein
the pump drive circuit control signal includes information designating the voltage of the drive voltage signal, and
the control unit adjusts the step-up control signal so that the drive voltage signal has the voltage designated by the pump drive circuit control signal.

27. The liquid discharge apparatus according to claim 25, wherein
the pump drive circuit control signal includes information designating the voltage of the drive voltage signal,
the liquid discharge head further includes a circuit configured to generate a voltage sensing signal indicating the voltage of the drive voltage signal, and
the control unit adjusts the step-up control signal so that the voltage of the drive voltage signal, which is indicated by the voltage sensing signal becomes equal to the voltage designated by the pump drive circuit control signal.

28. The liquid discharge apparatus according to claim 25, wherein
the pump drive circuit control signal includes information designating the period of the alternating-current conversion control signal, and
the control unit imparts a period in accordance with the designation by the pump drive circuit control signal to the alternating-current conversion control signal.

29. The liquid discharge apparatus according to claim 25, wherein
the liquid discharge head further includes a circuit configured to generate a voltage sensing signal indicating the voltage of the drive voltage signal, and
in a case where the voltage of the drive voltage signal, which is indicated by the voltage sensing signal has exceeded maximum allowable voltage, the control unit sets the voltage of the drive voltage signal generated by the step-up circuit to be lower than the maximum allowable voltage or to be 0 V by adjusting the step-up control signal.

30. The liquid discharge apparatus according to claim 25, wherein
the liquid discharge head further includes a circuit configured to generate a voltage sensing signal indicating the voltage of the drive voltage signal,
the voltage of the drive voltage signal is designated by the liquid discharge apparatus, and
in a case where the voltage of the drive voltage signal, which is indicated by the voltage sensing signal has exceeded maximum allowable voltage, the control unit sets the voltage of the drive voltage signal generated by the step-up circuit to be lower than the maximum allowable voltage or to be 0 V by intervening the designation of the voltage of the drive voltage signal by the liquid discharge apparatus.

31. The liquid discharge apparatus according to claim 25, wherein the control unit is provided at any of a carriage board provided at a carriage on which the liquid discharge head is mounted, a main board provided at a body of the liquid discharge apparatus, and a relay board inserted between the main board and the carriage board.

32. The liquid discharge apparatus according to claim 25, wherein the liquid discharge head further includes
a first pressure adjustment unit disposed between an exit of the circulating pump and an entrance of the supply flow path and configured to adjust the pressure of liquid at the entrance of the supply flow path, and
a second pressure adjustment unit disposed between an entrance of the circulating pump and an exit of the collection flow path and configured to adjust pressure at the exit of the collection flow path.

33. A liquid discharge apparatus comprising:
a liquid discharge head including
a discharge unit configured to discharge liquid inside a pressure chamber,
a supply flow path through which liquid to be supplied to the pressure chamber flows,
a collection flow path that is connected to the supply flow path through the pressure chamber and through which liquid collected from the pressure chamber flows,
a circulating pump capable of supplying liquid to the pressure chamber through the supply flow path, collecting liquid from the pressure chamber through the collection flow path, and recirculating collected liquid to the supply flow path based on an alternating-current pump drive signal, and
a pump drive circuit configured to generate the pump drive signal by stepping up and converting to alternating current a direct-current reference voltage signal having voltage lower than the peak-to-peak voltage of the pump drive signal based on a composite control signal; and
a control unit configured to generate the composite control signal based on a pump drive circuit control signal.

34. The liquid discharge apparatus according to claim 33, wherein
the pump drive circuit control signal includes information designating the voltage of the pump drive signal, and
the control unit adjusts the composite control signal so that the pump drive signal has the voltage designated by the pump drive circuit control signal.

35. The liquid discharge apparatus according to claim 33, wherein
the pump drive circuit control signal includes information designating the voltage of the pump drive signal,
the liquid discharge head further includes a circuit configured to generate a voltage sensing signal indicating the voltage of the pump drive signal, and
the control unit adjusts the composite control signal so that the voltage of the pump drive signal, which is indicated by the voltage sensing signal becomes equal to the voltage designated by the pump drive circuit control signal.

36. The liquid discharge apparatus according to claim 33, wherein
the pump drive circuit control signal includes information designating the period of the composite control signal, and
the control unit imparts a period in accordance with the designation by the pump drive circuit control signal to the composite control signal.

37. The liquid discharge apparatus according to claim 33, wherein
the liquid discharge head further includes a circuit configured to generate a voltage sensing signal indicating the voltage of the pump drive signal, and
in a case where the voltage of the pump drive signal, which is indicated by the voltage sensing signal has exceeded maximum allowable voltage, the control unit sets the voltage of the pump drive signal generated by the pump drive circuit to be lower than the maximum allowable voltage or to be 0 V by adjusting the composite control signal.

38. The liquid discharge apparatus according to claim 33, wherein
the liquid discharge head further includes a circuit configured to generate a voltage sensing signal indicating the voltage of the pump drive signal,
the voltage of the pump drive signal is designated by the liquid discharge apparatus, and
in a case where the voltage of the pump drive signal, which is indicated by the voltage sensing signal has exceeded maximum allowable voltage, the control unit sets the voltage of the pump drive signal generated by the pump drive circuit to be lower than the maximum allowable voltage or to be 0 V by intervening the designation of the voltage of the pump drive signal by the liquid discharge apparatus.

39. The liquid discharge apparatus according to claim 33, wherein the control unit is provided at any of a carriage board provided at a carriage on which the liquid discharge head is mounted, a main board provided at a body of the liquid discharge apparatus, and a relay board inserted between the main board and the carriage board.

40. The liquid discharge apparatus according to claim 33, wherein the liquid discharge head further includes
a first pressure adjustment unit disposed between an exit of the circulating pump and an entrance of the supply flow path and configured to adjust the pressure of liquid at the entrance of the supply flow path, and
a second pressure adjustment unit disposed between an entrance of the circulating pump and an exit of the collection flow path and configured to adjust pressure at the exit of the collection flow path.
